(19) United States
(12) Patent Application Publication
(10) Pub. No.: US 2012/0213169 A1
(43) Pub. Date: Aug. 23, 2012

(54) METHOD AND APPARATUS FOR IMPLEMENTING DOWNLINK MULTIPLE-INPUT MULTIPLE-OUTPUT TRANSMISSION

(75) Inventors: Yi WANG, Beijing (CN); Yi ZHANG, Beijing (CN); Yuantao ZHANG, Beijing (CN); Jian WANG, Beijing (CN)

(73) Assignee: FUJITSU LIMITED, Kawasaki-shi (JP)

(21) Appl. No.: 13/399,289

(22) Filed: Feb. 17, 2012

Related U.S. Application Data
(63) Continuation of application No. PCT/CN2010/076070, filed on Aug. 17, 2010.

(30) Foreign Application Priority Data
Aug. 20, 2009 (CN) 200910171314.7

(51) Int. Cl. H04W 72/10; H04L 27/28

(52) U.S. Cl. 370/329

(57) ABSTRACT

User scheduling used in a downlink multiple-input-multiple-output (MIMO) transmission, including with respect to each of user groups in which the users having the same Precoding Matrix Indicator (PMI), causing to complement each other based on a predetermined scheduling rule, according to the information fed back by the users in a single-user feedback manner of the SU-MIMO, to form a candidate user set; and selecting a scheduled MU-MIMO transmission user set from all the candidate user sets. User feeding back and user selection and scheduling used in a downlink MIMO transmission is further provided and includes selecting and scheduling, based on a predetermined scheduling rule, according to at least two CQIs fed back by each user, so as to determine a scheduled MU-MIMO transmission user set.

This is a continuation of Application No. PCT/CN2010/076070, filed on Aug. 17, 2010, now pending, which claims priority to Chinese Patent Application No. 200910171314.7, filed on Aug. 20, 2009, the contents of both are herein wholly incorporated by reference.

### FIELD OF THE INVENTION

The present invention relates in general to the field of communication technique, and in more particular to a method and a device for implementing a downlink multiple-input-multiple-output (MIMO) transmission in a telecommunication system.

### BACKGROUND OF THE INVENTION

The next generation wireless telecommunication system of 3GPP, i.e. Long Term Evolution (LTE)-Advanced, requires 1 Gps peak rate and 30 bps/Hz peak spectrum effectiveness to be provided for the downlink, which brings challenge to the physical layer transmission scheme in the system. In the Multi-User Multiple-Input Multiple-Output (MU-MIMO) transmission, multiple data streams that occupy the same resources in time and frequency domain are sent to different users by the base station. According to this MU-MIMO transmission, the capacity of the broadcasting channels in the multiuser system is fully utilized, the multiuser diversity gain in space dimension is obtained, and the demand of the LTE-Advanced (LTE-A) is better met.

The LTE system supports the MU-MIMO transmission scheme, so as to obtain a better system throughput, however in selection and scheduling of the user, there are following problems. (1) Upon estimating the Channel Quality Indicator (CQI), each user does not know the pre-coding matrix used by other users, thus the estimation value of the CQI is not accurate, and this mismatching in CQI affects the performance of the system. (2) Each user terminal selects the pre-coding vector independently, and thus it can not be ensured that the mutual interference between the multiple users is well suppressed in the system. (3) The LTE system supports only the single-rank transmission of each user. With the increase in the number of the antenna in the transmitting device, the signaling overhead in this transmission manner is significantly increased. In order to further obtain the multiuser scheduling gain and decrease the signaling overhead, the system needs to support the high-rank transmission of each user. (4) The signal-user system and the multi-user system use the same feed manner, therefore it is impossible to provide feedback information enough for further improving the system performance. Those problems and limitations require that a novelty schedule of user feeding back and user selection and scheduling is to be designed for the MU-MIMO transmission in the LTE-A system, so as to improve the system performance.

Some references are given in the following, so as to facilitate the basic understanding of the related background knowledge and the existing problems in the downlink MU-MIMO transmission mentioned in the present invention, which will be incorporated here by reference in entirety, as described in detail in this description.
1. [patent document 1]: PCT international patent application No. WO 2009083783 A2, published on Jul. 9, 2009, entitled “Optimal user pairing for downlink multiuser MIMO”, in the names of Hottinen Ari Tanapi et al.;
2. [patent document 2]: US patent application No. US 20080025336 A1, published on Jan. 31, 2008, entitled “Apparatus and method for scheduling multiuser/signal user in multiple input multiple output (MIMO) system”, in the names of Myeon-Kyun CHO et al.;
3. [patent document 3]: international patent application No. WO 2008049366 A1, published on May 2, 2008, entitled “SDMA Access codebook constructing method and apparatus thereof and scheduling method and apparatus and system thereof”, in the names of Yongming Huang et al.,
4. [patent document 4]: US patent application No. US 20070066229 A1, published on Mar. 22, 2007, entitled “Method and system for finding a threshold for semi-orthogonal user group selection in multiuser MIMO downlink transmission”, in the names of Chenjing Zhang et al.;
5. [patent document 5]: US patent application No. US 20070064829 A1, published on Mar. 22, 2007, entitled “Method and system for a simplified user group selection scheme with finite-rate channel state information feedback for FDD multiuser MIMO downlink transmission”, in the names of Jun Zheng et al.;
6. [patent document 6]: US patent application No. US 20060209764 A1, published on Sep. 21, 2006, entitled “User scheduling method for multiuser MIMO communication system”, in the names of Ho-Jin Kim et al.; and
7. [non-patent document 1]: 3GPP TR36.913., “Requirements for further advancements for Evolved Universal Terrestrial Radio Access (E-UTRA)”.

### SUMMARY OF THE INVENTION

In view of the above mentioned problem and drawbacks in the prior art, the present invention provides an improved scheme of user feeding back and user selection and scheduling for use in the downlink MU-MIMO transmission in the LTE system, for overcoming one or more of the above problems.

According to an embodiment of the present invention, a method of user selection and user scheduling used in a dynamic switching between downlink multi-user multiple-input-multiple-output (MU-MIMO) transmission and downlink single-user multiple-input-multiple-output (SU-MIMO) transmission in a telecommunication system is provided, and the method includes:

a user feeding back step of feeding back, by at least two users capable of implementing the MIMO transmission in the telecommunication system, information concerning the MIMO transmission in a single-user feedback manner of the SU-MIMO;

a user selecting step of grouping the users having the same Precoding Matrix Indicator (PMI) into one user group based on the information fed back by the at least two users; and with respect to each of the user groups, causing, based on a predetermined scheduling rule, the users in the user group, to complement each other with their respective different data transmission layers with relatively better transmission conditions, to form a candidate user set corresponding to the user group, wherein the candidate user set has an optimal combined transmission condition which is determined through the transmission conditions of the layers participating the complement; making a comparison between the candidate user sets obtained for all the user groups and the at least two users, and determining the candidate user set or the user having the highest priority to be the scheduled MU-MIMO transmission user set for performing the MU-MIMO transmission or the scheduled SU-MIMO transmission user for performing the SU-MUMO transmission, wherein the users in said scheduled MU-MIMO transmission user set have same rank or different ranks, and said priority is related to the communication quality of the telecommunication system; and

a user selection information transmitting step of transmitting the information concerning a transmission mode of each user in said scheduled MU-MIMO transmission user set and determined in the user selecting step to the respective scheduled users, which information being for use in the downlink MU-MIMO transmission.

According to another embodiment of the present invention, a transmitting device used in a dynamic switching between downlink multi-user multiple-input-multiple-output (MU-MIMO) transmission and downlink single-user multiple-input-multiple-output (SU-MIMO) transmission in a telecommunication system is provided, and the device includes:

a user selecting unit configured to group, based on information concerning the MIMO transmission fed back by at least two users capable of implementing the MIMO transmission in the telecommunication system in a single-user feeding back manner of the SU-MIMO, the users having the same Precoding Matrix Indicator (PMI) into one user group; and with respect to each of the user group, cause, based on a predetermined scheduling rule, the users in the user group to complement each other with their respective different data transmission layers with relatively better transmission conditions, to form a candidate user set corresponding to the user group, wherein the candidate user set has an optimal combined transmission condition which is determined through the transmission conditions of the layers participating the complement; make a comparison between the candidate user sets obtained for all the user groups with the at least two users, and determine the candidate user set or the user having the highest priority to be the scheduled MU-MIMO transmission user set for performing the MU-MIMO transmission or the scheduled SU-MIMO transmission user for performing the SU-MUMO transmission, wherein the users in said scheduled MU-MIMO transmission user set have same rank or different ranks, and said priority is related to the communication quality of the telecommunication system; and

a user selection information transmitting unit configured to transmit the information concerning a transmission mode of each user in said scheduled MU-MIMO transmission user set and determined by the user selecting unit to the respective scheduled users, which information being for use in the downlink MU-MIMO transmission.

According to further embodiment of the present, a method of user feeding back and user selection and scheduling used in a semi-static switching between downlink multi-user multiple-input-multiple-output (MU-MIMO) transmission and downlink single-user multiple-input-multiple-output (SU-MIMO) transmission in a telecommunication system is provided, and the method includes:

a user feeding back step of feeding back, by each of at least two users capable of implementing the MIMO transmission in the telecommunication system, at least two channel quality indicators (CQIs) corresponding one-to-one to data transmission layers of the user with relatively better transmission conditions;

a user selecting step of making selection and scheduling, based on a predetermined scheduling rule, with respect to the at least two users according to all the CQIs fed back by the at least two users, so as to determine a scheduled MU-MIMO transmission user set for performing the MU-MIMO transmission, wherein each user in said scheduled MU-MIMO transmission user set corresponds to one codeword or multiple codewords; and

a user selection information transmitting step of transmitting the information concerning a transmission mode of each user in said scheduled MU-MIMO transmission user set to the respective scheduled users, which information being for use in the downlink MU-MIMO transmission.

According to yet another embodiment of the present invention, a user equipment used in a semi-static switching between downlink multi-user multiple-input-multiple-output (MU-MIMO) transmission and downlink single-user multiple-input-multiple-output (SU-MIMO) transmission in a telecommunication system is provided, and the user equipment includes:

a user information feeding back unit configured to feed back to a transmitting device of the system at least two channel quality indicators (CQIs) corresponding one-to-one to data transmission layers of the user equipment with relatively better transmission conditions, wherein the CQIs are to be used in user selection and scheduling performed by the transmitting device during the semi-static switching between the MU-MIMO transmission and SU-MIMO transmission.

According to yet another embodiment of the present invention, a transmitting device used in a semi-static switching between downlink multi-user multiple-input-multiple-output (MU-MIMO) transmission and downlink single-user multiple-input-multiple-output (SU-MIMO) transmission in a telecommunication system is provided, and the transmitting device includes:

a user selecting unit configured to make selection and scheduling, based on a predetermined scheduling rule, with respect to at least two users capable of implementing the MIMO transmission in the telecommunication system according to all channel quality indicators (CQIs) which include at least two CQIs fed back by each of the at least two users and corresponding one-to-one to data transmission layers of the user with relatively better transmission conditions, so as to determine a scheduled MU-MIMO transmission user set, wherein each user in said scheduled MU-MIMO transmission user set corresponds to one codeword or multiple codewords; and

a user selection information transmitting unit configured to transmit the information concerning a transmission mode of each user in said scheduled MU-MIMO transmission user set to the respective scheduled users, which information being for use in the MU-MIMO transmission.

According to the method of user selection and user scheduling used in a dynamic switching between downlink MU-MIMO transmission and downlink SU-MIMO transmission, the user selections in the case of any rank are considered, the limitation to the single rank transmission of each user is eliminated, the range of the user selection is increased, and the system throughput is improved. Further, the problem of interference mismatching that occurs in the case of no information interaction between the users in the LTE-A system is better solved.

According to the method of user feeding back and user selection and scheduling used in a semi-static switching between downlink MU-MIMO transmission and downlink SU-MIMO transmission, CQIs of multiple codewords/layers are fed back in the user device, more information is provided for the user of the base station. According to this method, the multi-codewords/layers of each user is able to be supported in the base station, the selection range of the user is increased, and it is ensured that the system obtains improved multi-user diversity gain and system throughput. If multiple codewords of the same user are combined into one code, then the signaling overhead will be decreased.

### BRIEF DESCRIPTION OF THE DRAWINGS

The above and other objects, features and advantages of the present invention will be easier to be understood referring to the description made to the embodiment of the present invention in conjunction with the drawings. The components in the drawings are not drawn in proportion, but only meant to show the principle of the present invention. In the drawings, the same or similar reference numerals represent the same or similar technical characteristics. In which:

FIG. 1 is a simplified block diagram showing a basic constitution of telecommunication system achievable for MU-MIMO transmission;

FIG. 2 is an illustrative diagram showing a principle of an implement of a MU-MIMO transmission;

FIG. 3 is a simplified flow chart showing a method of user selection and user scheduling used in a dynamic switching between downlink multi-user multiple-input-multiple-output (MU-MIMO) transmission and downlink single-user multiple-input-multiple-output (SU-MIMO) transmission in a telecommunication system according to an embodiment of the present invention;

FIG. 4A-4D are illustrative diagrams showing mapping relation between layers in a space multiplexing transmission mode in a LTE system;

FIGS. 5A-5B show a precoding code book for use in a method of user selection and user scheduling as that shown in FIG. 6;

FIG. 6 is a simplified flow chart showing an specific example of a method of user selection and user scheduling according to FIG. 3;

FIGS. 7A-7C are schematic diagrams of a mode of a possible MU-MIMO user set forming of users with rank=2 and users with rank=3, in an example as that shown in FIG. 6;

FIG. 8 is a detailed flow chart showing a method of user selection and user scheduling for use in a dynamic switching between downlink MU-MIMO transmission and downlink SU-MIMO transmission as shown in FIG. 6;

FIG. 9 is a simplified block diagram showing a transmitting device used in a dynamic switching between downlink multi-user multiple-input-multiple-output (MU-MIMO) transmission and downlink single-user multiple-input-multiple-output (SU-MIMO) transmission in a telecommunication system according to an embodiment of the present invention;

FIG. 10 is a simplified flow chart showing a method of user feeding back and user selection and scheduling used in a semi-static switching between downlink multi-user multiple-input-multiple-output (MU-MIMO) transmission and downlink single-user multiple-input-multiple-output (SU-MIMO) transmission in a telecommunication system according to other embodiments of the present invention;

FIG. 11 is a simplified flow chart showing a specific example of a method of user feeding back and user selection and scheduling according to FIG. 10;

FIG. 12 is a detailed flow chart showing a method of user feeding back and user selection and scheduling for use in a semi-static switching between downlink MU-MIMO transmission and downlink SU-MIMO transmission as that shown in FIG. 11;

FIG. 13 is an illustrative diagram showing a transmission device used in a semi-static switching between downlink multi-user multiple-input-multiple-output (MU-MIMO) transmission and downlink single-user multiple-input-multiple-output (SU-MIMO) transmission in a telecommunication system according to an embodiment of the present invention; and

FIG. 14 is an illustrative diagram showing a user equipment used in a semi-static switching between downlink multi-user multiple-input-multiple-output (MU-MIMO) transmission and downlink single-user multiple-input-multiple-output (SU-MIMO) transmission in a telecommunication system according to an embodiment of the present invention.

### DETAILED DESCRIPTION OF THE INVENTION

The embodiment of the present invention will be described referring to the drawings hereinafter. In the present invention, the elements and the characteristics described in one drawing or one embodiment may be combined with the elements or characteristics described in one or more other drawings or embodiments. It should be noted that the representations and the descriptions of the components and the processes that are independent of the present invention and known to those skilled in the art are omitted in the drawings and the descriptions, so as to prevent the confusion from being caused to the understand of the present invention.

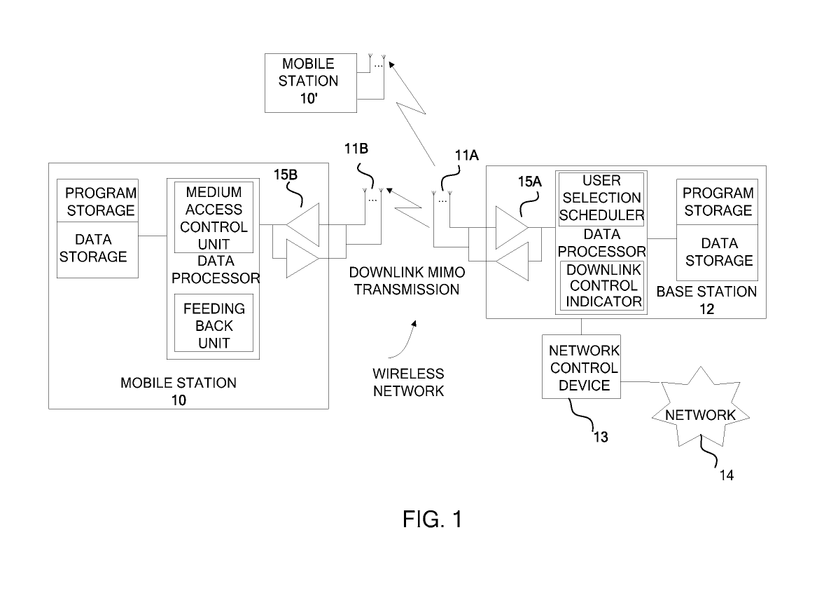

FIG. 1 is a simplified block diagram showing a basic constitution of telecommunication system for MU-MIMO transmission. As shown in FIG. 1, the mobile station (user equipment) 10, 10′ communicates with the base station 12 via a wireless net, for example for implementing downlink MU-MIMO transmission. The wireless network may include a network control device 13 or a gateway, which may provide connectivity to a network 14 (such as Internet). The mobile station 10 includes a storage including a data storage and a program storage; a data processor including a medium access unit and a feedback unit; a radio frequency (RF) transceiver 15B for two-way wireless communication with the base station 12; and multiple antennas 11B. The base station 12 includes multiple antennas 11A; a RF transceiver 15A; a data processor including a user selection scheduler and a downlink control indicator; and a storage including a data storage and a program storage. In performing the downlink transmission, the mobile station 10 and 10′ feed back the information concerning themselves to the base station 12, and the base station 12 performs user selection and scheduling for each mobile station by means of the user selection scheduler according to the received feedback information, so as to determine the MU-MIMO transmissions for which mobile stations will be performed. Then the mobile station is notified of the corresponding user selection information by the downlink control indicator, for use in downlink MU-MIMO transmission. Indeed, the base station 12 may also perform the SU-MIMO transmission with the mobile station 10 and 10′ respectively.

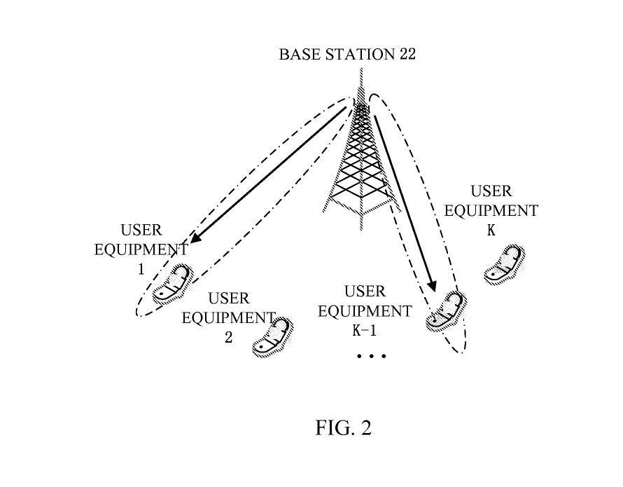

FIG. 2 shows a basic principle of a Multi-user Multiple-Input-Multiple-Output MU-MIMO transmission. As shown in FIG. 2, the base station 22 provides service for K user equipments, i.e. user equipment 1, 2, . . . , K. The base station 22 may select multiple users with relatively higher priority from the K users according to a certain scheduling strategy or scheduling rule, and provide simultaneously services for the multiple users in space multiplexing manner in the same time and frequency resource. In the case shown in FIG. 2, the user equipment 1 and the user equipment K-1 are the scheduled users selected to perform the downlink MU-MIMO transmission with the base station 22.

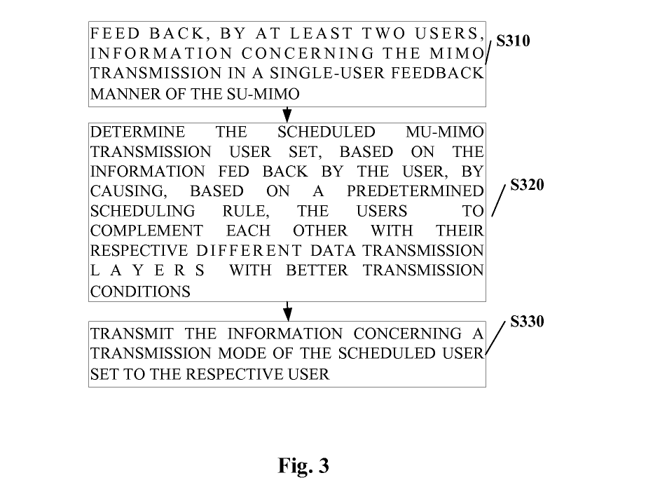

FIG. 3 is a simplified flow chart showing a method of user selection and user scheduling used in a dynamic switching between downlink multi-user multiple-input-multiple-output (MU-MIMO) transmission and downlink single-user multiple-input-multiple-output (SU-MIMO) transmission in a telecommunication system according to an embodiment of the present invention. As shown in FIG. 3, in a user feeding back step S310, at least two users capable of implementing the MIMO transmission in the telecommunication system feed back information concerning the MIMO transmission in a single-user feedback manner of the SU-MIMO. In a user selecting step S320, the users having the same Precoding Matrix Indicator (PMI) are grouped into one user group based on the information fed back by the at least two users; and with respect to each of the user groups, based on a predetermined scheduling rule, the users in the user group are caused to complement each other with their respective different data transmission layers with relatively better transmission conditions to form a candidate user set corresponding to the user group, wherein the candidate user set has an optimal combined transmission condition which is determined through the transmission conditions of the layers participating the complement. A comparison is made between the candidate user sets obtained for all the user groups and the at least two users, and the candidate user set or the user having the highest priority is determined to be the scheduled MU-MIMO transmission user set for performing the MU-MIMO transmission or the scheduled SU-MIMO transmission user for performing the SU-MUMO transmission. The users in said scheduled MU-MIMO transmission user set have same rank or different ranks, and the priority is related to the communication quality of the telecommunication system. In a user selection information transmitting step S330, the information concerning a transmission mode of each user in said scheduled MU-MIMO transmission user set and determined in step S320 is transmitted to the respective scheduled users, which information being for use in the downlink MU-MIMO transmission.

The method of user selection and user scheduling according to the embodiment of the present invention will be described in detail in conjunction with a specific example, so as to facilitate to understand the essence of the method of user selection and user scheduling used in a dynamic switching between downlink MU-MIMO transmission and downlink SU-MIMO transmission.

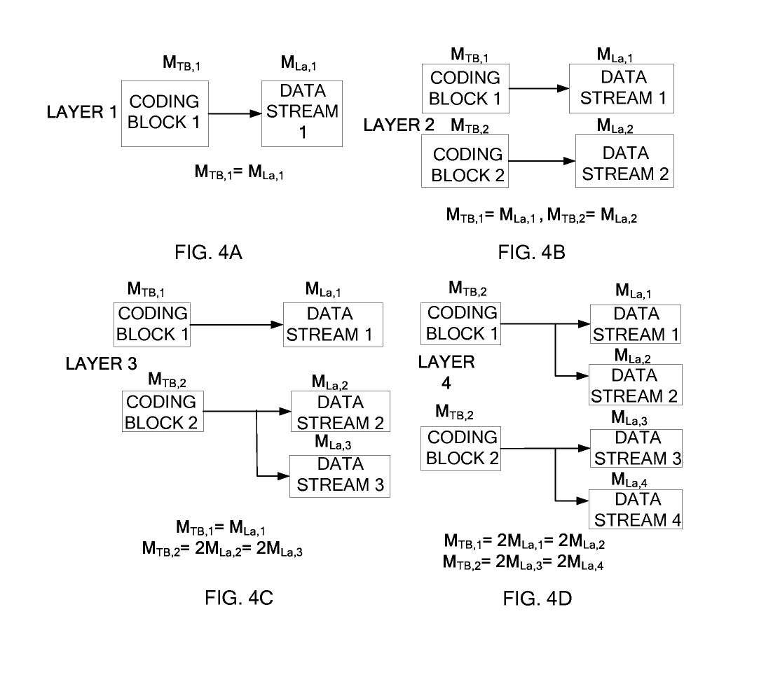

Firstly, the mapping relation between the layer in space multiplexing transmission mode in the present LTE system is described simply referring to FIGS. 4A-4D. if the number (rank) of the data transmission layer supportable by the system is less than 3, then the single codeword is mapped onto the single data transmission layer, as shown in FIGS. 4A, 4B; and if the rank of the data transmission layer supportable by the system is equal to or larger than 3, then single codeword may be mapped onto the two data transmission layers, as shown in FIGS. 4C, 4D. In the Figures, M_{TB,i} is the number of the symbols carried by the ith coding block, and M_{La,i} is the number of the symbols carried by the ith data transmission layer, i.e. the amount of the carried data.

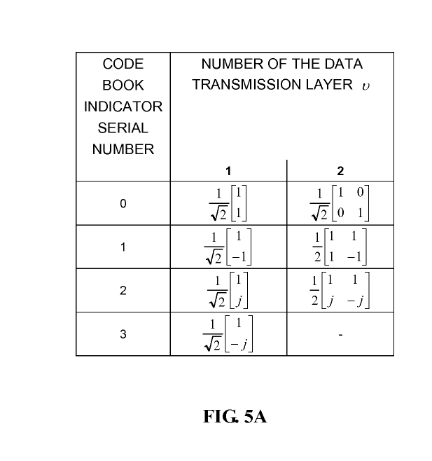

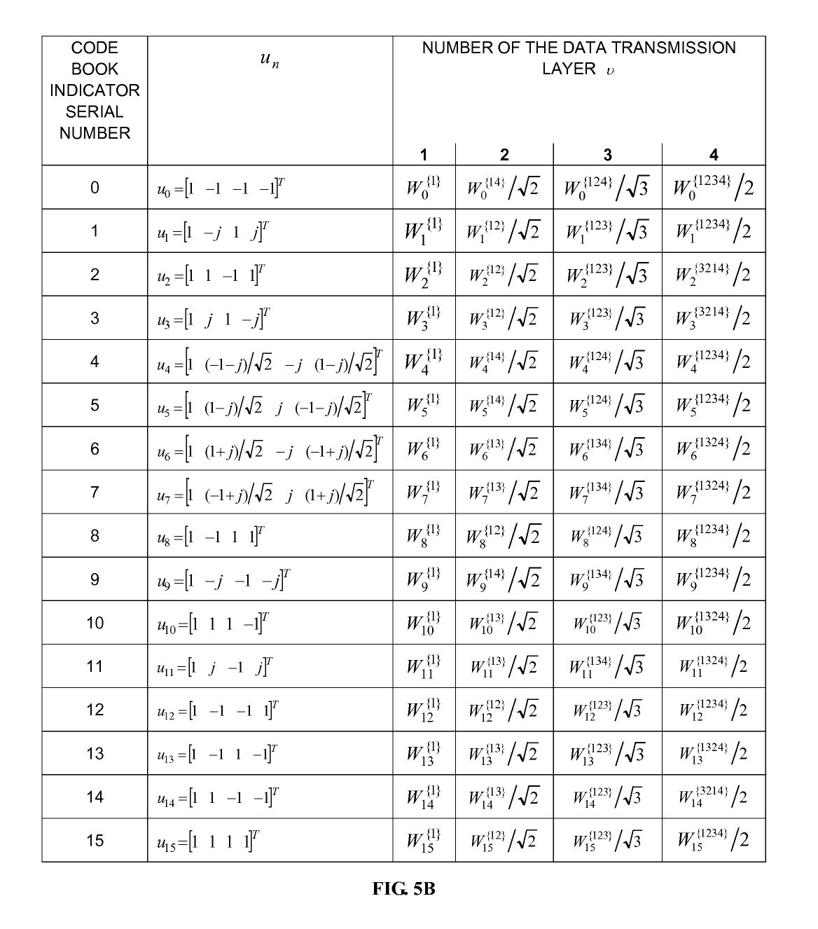

Further, it is provided that the code book for use in the method of user selection and user scheduling according to this embodiment is shown in FIGS. 5A-5B, which code book is the present defined code book in the LTE standard and designed according to the following three principles.

individual elements in the code book have a constant amplitude, so as to ensure a balance transmission power;

the code books corresponding to the same code book indicator serial number and different data transmission layer number (rank) satisfy the nestification characteristics. That is to say, if the code book indicator serial numbers are the same, the pre-coding matrix with lower rank (corresponds to “the number of the data transmission layer” in the second column to the left in the code book shown in FIGS. 5A-5B) consists of certain columns in the pre-coding matrix with higher rank, so as to simplify the calculation of the CQI in different ranks (except the case in which the code book indicator serial number in the code book Tx=2 is 0);

the QPSK modulation symbols are used to represent the code book Tx=2 of the transmitting antenna, and the 8PSK modulation symbols are used to represent the code book Tx=4 of the transmitting antenna, so as to decrease the complex number multiplications as many as possible.

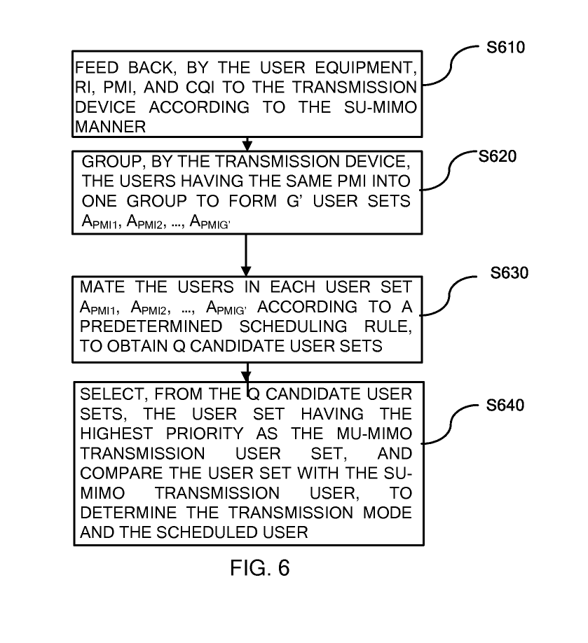

FIG. 6 shows a flow chart of a method of user selection and user scheduling according to this specific example. As shown in FIG. 6, the method includes specifically the following steps.

In a step S610, the user calculates the maximum number of the data transmission layers supportable by the user, i.e. the rank of the channel matrix, in the SU-MIMO transmission manner according to the estimated information on the downlink channel; feeds back a channel rank indicator RI to the transmitting device (such as the base station); and feeds back the present optimal PMI (pre-coding matrix indicator, corresponding to the code book indicator serial number of the column on the far left in the code book shown in FIGS. 5A-5B) and the corresponding channel quality indicator (CQI).

In a step S620, the transmitting device collects the feedback information on all the M users to which service is provided, including RI, PMI and CQI information, and groups the users having the same PMI into G′ user sets A_{PMI}_{₀}, A_{PMI}_{₁}, . . . , A_{PMI}_{_{G}}, G′≦G, in which PMI_{g} represents the value of the PMI is g, and the maximum value G of g is related to the transmitting antenna of the base station. According to the code book as that shown in FIGS. 5A-5B, if the transmitting antenna Tx=2, then G=3; and the transmitting antenna Tx=4, then G=15.

In a step S630, users are selected, according to certain scheduling strategy, from the G′ user set A_{PMI}_{₀}, A_{PMI}_{₁}, . . . , A_{PMI}_{_{g′}} obtained in the step S620 to mate each other. That is to say, several user having better transmission conditions are selected from each user set A_{PMI}_{_{g}} to mate each other, the mated user set composes a candidate MU-MIMO transmission user set, and the number (i.e. the corresponding rank) of the data transmission layer of the MU-MIMO transmission corresponding to this candidate MU-MIMO transmission user set is equal to the RI fed back by one user in the candidate MU-MIMO transmission user set, in other words, the pre-coding matrix of the MU-MIMO transmission is caused to be the same as the pre-coding matrix of one user in the set. Thus, it may be ensured that there is at least one user that does not has the problem of mismatching CQI, and due to the orthogonality of the code book defined by the LTE, the interference between individual users in the MU-MIMO transmission is also decreased or eliminated. Therefore, with respect to G′ user sets, Q candidate MU-MINO transmission use sets are obtained, with Q equal to or less than G′.

In the above step S630, the process of causing the users in each user set A_{OMI}_{_{g}} to mate each other according to certain scheduling strategy is actually the process of causing the users having better transmission conditions to “complement each other”. For example, if the nth data transmission layer of the user N has a better transmission condition, and the mth data transmission layer of the user M has a better transmission condition, then the nth data transmission layer or other possible data transmission layers of the user M may be replaced by the nth data transmission layer of the user N, alternatively, mth data transmission layer or other possible data transmission layers of the user N may be replaced by the mth data transmission layer of the user M, so as to perform the mating or combination, so that the transmission condition of the user set for MU-MIMO transmission obtained after the replacement process is better than both the single user N and the single user M. This mating process may be considered as the “complement” made to the mated user N and user M based on their data transmission layers having better transmission conditions, and the transmission condition of the set related to the mated MU-MIMO transmission users may be determined by the transmission conditions of the data transmission layers of the user participating in the mating. It should be noted that, in the “complement” mating process described here, whether the user N and the user M participating in the mating may be mated and the specific MU-MIMO transmission mode after the mating depend on the MU-MIMO transmission mode supportable by the system. This will be further described later.

In a step S640, the transmission device selects a candidate MU-MIMO transmission user set having optimal transmission condition from all the Q candidate MU-MIMO transmission user sets, for using as the scheduled MU-MIMO transmission user set. Further, the scheduled MU-MIMO transmission user set may be compared with the SU-MIMO transmission users in the system (i.e. all the single users performing the MIMO) according to a certain scheduling strategy, to select the MU-MIMO transmission user set or the SU-MIMO transmission user having the highest priority, for using as the scheduled user set or user performing the downlink MU-MIMO transmission or the downlink SU-MIMO transmission.

Until now, the user selection and the user scheduling processes during the dynamic switching between the downlink MU-MIMO transmission and the downlink SU-MIMO transmission have been completed.

As mentioned above, the code book used in this embodiment is the code book as that shown in FIGS. 5A-5B. With respect to this code book, if the PMIs fed back in the SU-MIMO manner by the users are not eh same, then the orthogonality between the composed pre-coding vectors of the MU-MIMO transmission may be destroyed, and thus interference between the users may be introduced. Moreover, the different PMIs make the pre-coding vector interfering with the transmission uncertain, so that the CQI calculated by the user in SU-MIMO manner is not accurate, then CQI mismatching is caused and thus the system throughput is decreased. However, according to the method of user selection and user scheduling according to the embodiment of the present invention, the users having the same PMI are mated and the pre-coding matrix of the mated MU-MIMO is caused to be the same as the pre-coding matrix of one of the users, therefore the interference between the users in the MU-MIMO is avoided, and the problem of mismatching between the SU-MIMO and the MU-MIMO transmissions is better solved.

Further, if the MU-MIMO transmission is determined to be performed by comparing in the step S640, then a modulation and coding scheme is selected for the scheduled MU-MIMO transmission user set according to the CQI fed back by this user set, so as to code and modulate the data of this user set. Then a pre-coding matrix for the MU-MIMO transmission is selected for the scheduled MU-MIMO transmission user set according to the PMI fed back by this user set, so as to pre-code the coded and modulated data. And then the transmission device indicates, by the downlink control channel indicator, to the MU-MIMO transmission user set the pre-coding matrix, the number of the data transmission layer (rank), the mapping relation between the codeword and the data transmission layer, and the corresponding modulation and coding information.

If the SU-MIMO transmission is determined to be performed by comparing in the step S640, then a modulation and coding scheme is selected for the SU-MIMO transmission user according to the CQI fed back by this user, so as to code and modulate the data of this user. Then a pre-coding matrix for the SU-MIMO transmission is selected for the SU-MIMO transmission user according to the PMI fed back by this user, so as to pre-code the coded and modulated data. And then the transmission device indicates, by the downlink control channel indicator, to the SU-MIMO transmission user the pre-coding matrix, the number of the data transmission layer, and the data transmission layer, and the corresponding modulation and coding information.

The above processes of modulation and coding, pre-coding, sending the information concerning the transmission mode to the user and the like for the MU-MIMO user set or the SU-MIMO user after the user selection and scheduling are completed, may be implemented in the present processing manner, which will not be described in detail here.

It can be seen that, this down-link in the downlink MIMO system may be switched between the SU-MIMO transmission and the MU-MIMO transmission. Thereby the data transmission may be implemented by the system in the optimal transmission manner at any time, so that the desirable telecommunication efficiency of the system is obtained.

In consisting the Q candidate MU-MIMO transmission user sets, the RI of the user in each candidate user set may be the same or not. This will be further described in detail in the following.

In selecting Q candidate MU-MIMO transmission user sets from the G′ user sets, and in selecting the MU-MIMO transmission user set or the SU-MIMO transmission user to be used as the scheduled one having the highest priority from the Q candidate MU-MIMO transmission user set and the SU-MIMO transmission user in the system, the scheduling strategy or the scheduling rule is to maximize the system throughput. In other words, the priority corresponding to the MU-MIMO transmission user set or the SU-MIMO transmission user may be the parameters or the indexes concerning the telecommunication quality of the telecommunication system. The above scheduling strategy or rule may also be other scheduling strategy giving attention to equality of the user, delay characteristic, and/or combination thereof. Correspondingly, the priority may represent any one performance index of the system throughput, the equality of the user, and the delay characteristic, or may represent the any weighted combination of these performance indexes.

The pre-coding matrix, the number of the data transmission layer and the mapping relation between the data transmission layer, i.e. which data transmission layer of the MU-MIMO transmission the codeword of the scheduled user is mapped onto, that are used by the scheduled user may be indicated by the transmission device through suitable downlink control channel, such as a physical downlink control channel.

As described above, in performing the user mating with respect to each user set of the user set A_{PMI}_{₀}, A_{PMI}_{₁}, . . . , A_{PMI}_{_{G}}, it is necessary that the users with the data transmission layer having relatively better transmission condition are mated based on their respective data transmission layer, so as to obtain the candidate MU-MIMO transmission user set. To better understand the process of this “complement” mating, in the following, at first, the basic principle of the complement mating between the two users and all the obtained possible MU-MIMO transmission modes after the mating will be described in detail by taking the codebook defined in the LTE system (referring to FIGS. 5A-5B) as an example. It should be noted that the MU-MIMO transmission modes obtained through the mating also need to be coincident with the mapping relation between the codeword supportable by the system and the data transmission layer, and to facilitate the description, the mapping relations supportable by the LTE presently shown in FIGS. 5A-5D are taken as an example.

If the number of the transmission antenna in the system is Tₓ=2, then the complement mating of the users in one user set A_{PMIg} may include the following two cases. In which the definition matrix \tilde{w}ᵣ^{{d}} is the dth column of the pre-coding matrix with RI=4, and the code book as that shown in FIG. 5A is used.

A first case: the user i feeds back RI=1, the user j feeds back RI=2, the two users may be combined for the MU-MIMO transmission mode with 2 data transmission layers. The resource may be mapped in the following two manners. A first manner: the user i is mapped onto the first data transmission layer, with the corresponding pre-coding vector being \tilde{w}₁^{{1}}, and the user j is mapped onto the second data transmission layer, with the corresponding pre-coding vector being \tilde{w}₂^{{2}}; and a second manner: the user i is mapped onto the second data transmission layer, with the corresponding pre-coding vector being \tilde{w}₁^{{1}}, and the user j is mapped onto the first data transmission layer, with the corresponding pre-coding vector being \tilde{w}₂^{{1}}. After the user i and the user j are mated, the corresponding pre-coding matrix W_{MU} may be obtained by performing power normalization on the matrix [\tilde{w}₁^{{1}}\tilde{w}₂^{{2}}] or the matrix [\tilde{w}₂^{{1}}\tilde{w}₁^{{1}}]. The pre-coding matrix W_{MU} must have individual orthometric columns, and \tilde{w}₁^{{1}}=\tilde{w}₂^{{1}} or \tilde{w}₁^{{1}}=\tilde{w}₂^{{2}}, otherwise the mating may not be performed. That is to say, the pre-coding matrix of the obtained MU-MIMO transmission user set need to be the same as the pre-coding matrix of one of the user (the user j here) participating the mating.

A second case: the user i feeds back RI=2, the user j feeds back RI=2, the two users may be combined for the MU-MIMO transmission mode with 2 data transmission layers. The resource may be mapped in the following two manners. A first manner: the user i is mapped onto the first data transmission layer, with the corresponding pre-coding vector being \tilde{w}₂^{{1}}, and the user j is mapped onto the second data transmission layer, with the corresponding pre-coding vector being \tilde{w}₂^{{2}}; and a second manner: the user i is mapped onto the second data transmission layer, with the corresponding pre-coding vector being \tilde{w}₂^{{2}}, and the user j is mapped onto the first data transmission layer, with the corresponding pre-coding vector being \tilde{w}₂^{{1}}.

If the number of the transmission antenna is Tₓ=4, then the complement mating of the users in one user set A_{PMIg} may include the following cases. In which the definition matrix \tilde{w}ᵣ^{{d}} is the dth column of the pre-coding matrix with RI=r, and the code book as that shown in FIG. 5B is used.

A first case: the user i feeds back RI=1, the user j feeds back RI=2, the two users may be combined for the MU-MIMO transmission mode with 2 data transmission layers. The user i is mapped onto the first data transmission layer, with the corresponding pre-coding vector being \tilde{w}₁^{{1}}, and the user j is mapped onto the second data transmission layer, with the corresponding pre-coding vector being \tilde{w}₂^{{2}}.

A second case: the user i feeds back RI=2, the user j feeds back RI=2, the two users may be combined for the MU-MIMO transmission mode with 2 data transmission layers. The resource may be mapped in the following two manners. A first manner: the user i is mapped onto the first data transmission layer, with the corresponding pre-coding vector being \tilde{w}₂^{{1}}, and the user j is mapped onto the second data transmission layer, with the corresponding pre-coding vector being \tilde{w}₂^{{2}}; and a second manner: the user i is mapped onto the second data transmission layer, with the corresponding pre-coding vector being \tilde{w}₂^{{2}}, and the user j is mapped onto the first data transmission layer, with the corresponding pre-coding vector being \tilde{w}₂^{{1}}.

A third case: the user i feeds back RI=2, the user j feeds back RI=3, the two users may be combined for the MU-MIMO transmission mode with 2 or 3 data transmission layers.

In the case of the MU-MIMO transmission mode with 2 transmission layers, the user i is mapped onto the second data transmission layer, with the corresponding pre-coding vector being \tilde{w}₂^{{2}}, and the user j is mapped onto the first data transmission layer, with the corresponding pre-coding vector being \tilde{w}₃^{{1}}.

In the case of the MU-MIMO transmission mode with 3 transmission layers, the user i is mapped onto the first data transmission layer, with the corresponding pre-coding vector being \tilde{w}₂^{{1}}, and the user j is mapped onto the second and the third data transmission layers, with the corresponding pre-coding vector being \tilde{w}₃^{{2,3}}.

A fourth case: the user i feeds back RI=1, the user j feeds back RI=3, the two users may be combined for the MU-MIMO transmission mode with 3 data transmission layers. The user i is mapped onto the first data transmission layer, with the corresponding pre-coding vector being \tilde{w}₁^{{1}}, and the user j is mapped onto the second and the third data transmission layers, with the corresponding pre-coding vector being \tilde{w}₃^{{2,3}}.

A fifth case: the user i feeds back RI=3, the user j feeds back RI=3, the two users may be combined for the MU-MIMO transmission mode with 3 data transmission layers. The resource may be mapped in the following two manners. A first manner: the user i is mapped onto the first data transmission layer, with the corresponding pre-coding vector being and \tilde{w}₃^{{1}}, and the user j is mapped onto the second and the third data transmission layers, with the corresponding pre-coding vector being \tilde{w}₃^{{2,3}}; and a second manner: the user i is mapped onto the second and the third data transmission layers, with the corresponding pre-coding vector being \tilde{w}₃^{{2,3}}, and the user j is mapped onto the first data transmission layer, with the corresponding pre-coding vector being \tilde{w}₃^{{1}}.

A sixth case: the user i feeds back RI=3, the user j feeds back RI=4, the two users may be combined for the MU-MIMO transmission mode with 3 or 4 data transmission layers.

In the case of the MU-MIMO transmission mode with 3 transmission layers, the user i is mapped onto the first data transmission layer, with the corresponding pre-coding vector being \tilde{w}₃^{{1}}, and the user j is mapped onto the second and the third data transmission layers, with the corresponding pre-coding vector being \tilde{w}₄^{{3,4}} or \tilde{w}₄^{{1,2}}. After the user i and the user j are mated, the corresponding pre-coding matrix W_{MU} may be obtained by performing power normalization on the matrix [\tilde{w}₃^{{1}}\tilde{w}₄^{{3,4}}] or the matrix [\tilde{w}₃^{{1}}\tilde{w}₄^{{1,2}}]. And the pre-coding matrix W_{MU} must have individual orthometric columns, and \tilde{w}₄^{{3,4}}=\tilde{w}₃^{{2,3}} \tilde{w}₄^{{3,4}}=\tilde{w}₃^{{3,2}} or \tilde{w}₄^{{1,2}}=\tilde{w}₃^{{2,3}} \tilde{w}₄^{{1,2}}=\tilde{w}₃^{{3,2}}, otherwise the mating may not be performed. That is to say, the pre-coding matrix of the obtained MU-MIMO transmission user set need to be the same as the pre-coding matrix of one of the user (the user i with RI=3 here) participating the mating.

In the case of the MU-MIMO transmission mode with 4 transmission layers, the resource may be mapped in the following two manners. A first manner: the user i is mapped onto the third and the fourth data transmission layers, with the corresponding pre-coding vector being \tilde{w}₃^{{3,2}}, and the user j is mapped onto the first and the second data transmission layers, with the corresponding pre-coding vector being \tilde{w}₄^{{1,2}}. After the user i and the user j are mated, the corresponding pre-coding matrix W_{MU} must have individual orthometric columns, and \tilde{w}₃^{{2,3}}=\tilde{w}₄^{{3,4}} or \tilde{w}₃^{{3,2}}=\tilde{w}₄^{{3,4}}, otherwise the mating may not be performed. And a second manner: the user i is mapped onto the first and the second data transmission layers, with the corresponding pre-coding vector being \tilde{w}₃^{{3,2}}, and the user j is mapped onto the third and the fourth data transmission layers, with the corresponding pre-coding vector being \tilde{w}₄^{{3,4}}. After the user i and the user j are mated, the corresponding pre-coding matrix W_{MU} must have individual orthometric columns, and \tilde{w}₃^{{2,3}}=\tilde{w}₄^{{1,2}} or \tilde{w}₃^{{3,2}}=\tilde{w}₄^{{1,2}}, otherwise the mating may not be performed.

A seventh case: the user i feeds back RI=4, the user j feeds back RI=4, the two users may be combined for the MU-MIMO transmission mode with 4 data transmission layers. The resource may be mapped in the following two manners. A first manner: the user i is mapped onto the first and the second data transmission layers, with the corresponding pre-coding vector being \tilde{w}₄^{{1,2}}, and the user j is mapped onto the third and the fourth data transmission layers, with the corresponding pre-coding vector being \tilde{w}₄^{{3,4}}; and a second manner: the user i is mapped onto the third and the fourth data transmission layers, with the corresponding pre-coding vector being \tilde{w}₄^{{3,4}}, and the user j is mapped onto the first and the second data transmission layers, with the corresponding pre-coding vector being \tilde{w}₄^{{1,2}}.

It can be seen that, the corresponding pre-coding matrix obtained by the user mating may be the same as the pre-coding matrix of one of the users. In other words, if a pre-coding matrix that is the same as the pre-coding matrix of one of the users after the combination of the pre-coding matrix of individual users, those users will not be complemented. Further, it can be seen that the rank of the user participating in the complement mating may be the same or not.

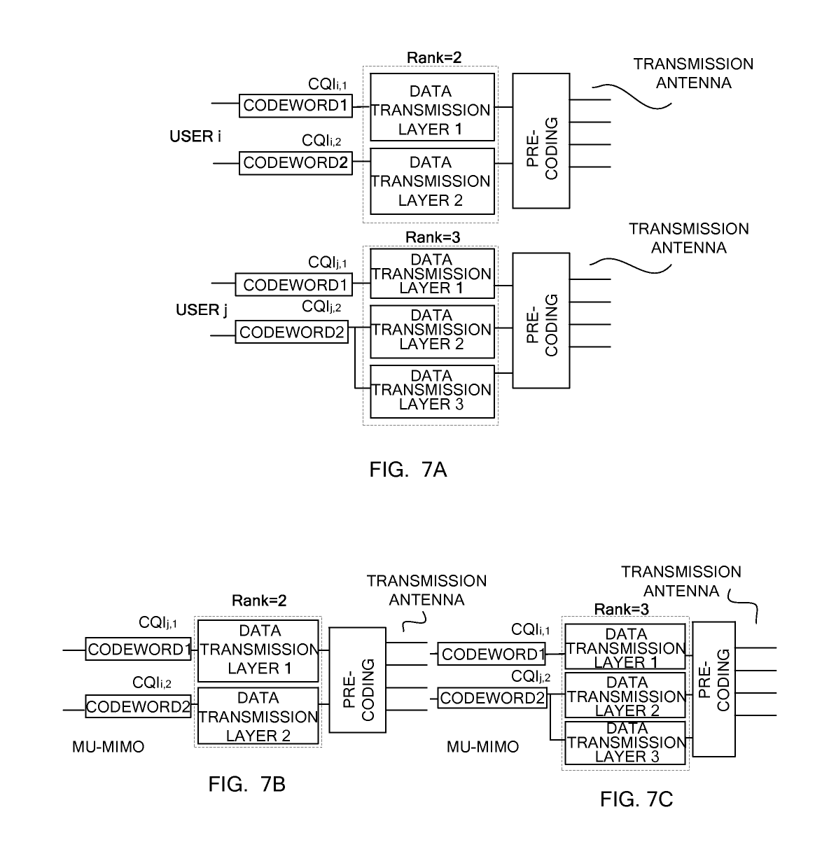

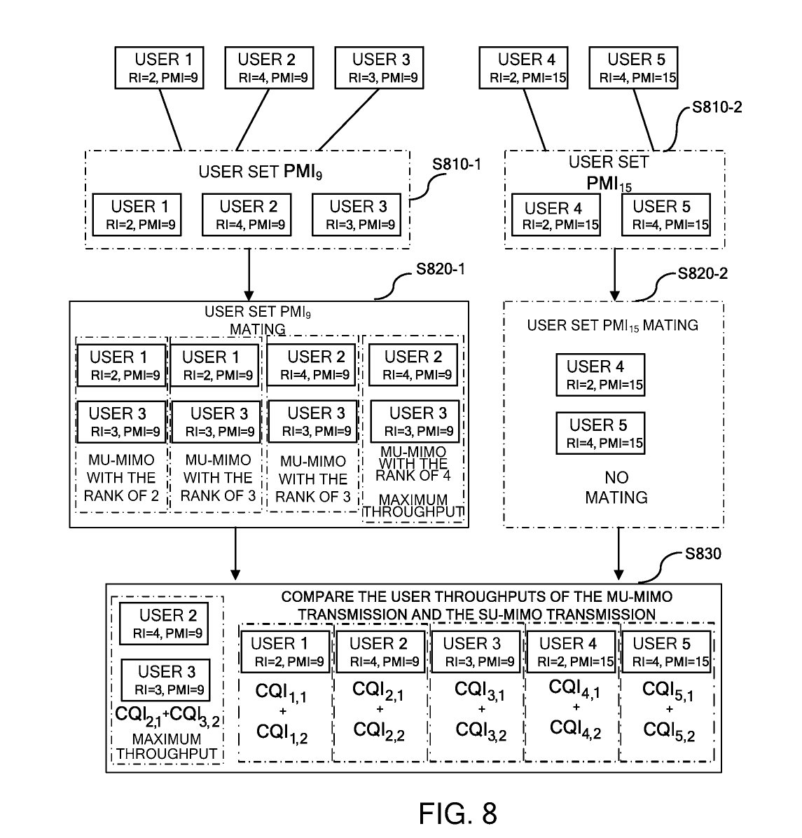

The possible user mating combination in the above third case may be described referring to FIGS. 7A-7C hereinafter, so as to understand the above complementation better.

FIG. 7A shows the mapping relation between respective codewords and data transmission layers of the user i and the user j. As shown in FIG. 7A, the codeword 1 of the user i is mapped onto the first data transmission layer, the codeword 2 of the user i is mapped onto the second data transmission layer; and the codeword 1 of the user j is mapped onto the first data transmission layer, the codeword 2 of the user j is mapped onto the second and the third data transmission layers.

FIG. 7B is an illustrative diagram of the MU-MIMO transmission mode with 2 data transmission layers. As shown in FIG. 7B, the user i is mapped onto the second data transmission layer, with the corresponding pre-coding vector being \tilde{w}₂^{{1}} and the corresponding feedback channel quality indicator being CQI_{i,2}; and the user j is mapped onto the first data transmission layer, with the corresponding pre-coding vector being \tilde{w}₂^{{2}} and the corresponding feedback channel quality indicator being CQI_{j,1}. This combination mode is equal to the user combination obtained by “complementing” or “exchanging” the second data transmission layer of the user i with the first data transmission layer of the user j.

FIG. 7C is an illustrative diagram of the MU-MIMO transmission mode with 3 data transmission layers. As shown in FIG. 7C, the user i is mapped onto the first data transmission layer, with the corresponding pre-coding vector being \tilde{w}₂^{{1}} and the corresponding feedback channel quality indicator being CQI_{i,1}; and the user j is mapped onto the second and the third data transmission layers, with the corresponding pre-coding vector being \tilde{w}₃^{{2,3}} and the corresponding feedback channel quality indicator being CQI_{j,2}. This combination mode is equal to the user combination obtained by “complementing” or “exchanging” the first data transmission layer of the user i with the second and the third data transmission layers of the user j.

Although the above are the cases in which the codebook defined by the LTE is used and it is assumed that the MU-MIMO transmission is in accordance with the mapping relation between the codeword and the data transmission layer as defined in FIGS. 4A-4D. It is easy to understand that, if the used code book and the mapping relation between the codeword and the data transmission layer change, various user combinations may still be obtained according to the above “complementation” mating principle. For example, it can be seen from FIGS. 5A-5B that, the code book defined by LTE has nestification and orthogonality characteristics. However, the above method of user selection and user scheduling of the present invention may also be adaptive to other types of code book, as long as this kind of code book has nestification characteristics. Because the above method of user selection and user scheduling of the present invention may eliminate the CQI mismatching between the mated users, as long as the code book has nestification characteristics. It can be seen from this that, the code book defined by LTE has both nestification and orthogonality characteristics, therefore in the user selection and scheduling according to the above example of the present invention, technical advantages, such as decreased CQI mismatching and decreased interference between the MU-MIMO users, may be obtained by using this kind of code book, so as to improve the system telecommunication efficiency. Thus the embodiments using the code book defined by LTE shown in FIGS. 5A-5B actually belong to a preferable embodiment.

FIG. 8 is a detailed flow chart showing an example of the method of downlink user selection as shown in FIG. 6. In this example, it is assumed that the number of the transmission antenna at the transmission device is Tₓ=4, the number of the receiving antenna at the user equipment is Rₓ=4, and the number of the users that are able to perform the downlink MIMO transmission and served by the base station is M=5. The scheduling strategy is the maximum total throughput widely used in the art. Corresponding to the LTE code book shown in FIG. 5B, the code with PMI=g is represented by W_{g}, and w_{g}^{{x}} represents the xth column in the W_{g}. It is assumed that RI=2, PMI=9 are fed back by the user 1, and the pre-coding matrix is W₉^{{14}}/\sqrt{2}; RI=4, PMI=9 are fed back by the user 2, and the pre-coding matrix is W₉^{{1234}}/2; RI=3, PMI=9 are fed back by the user 3, and the pre-coding matrix is W₉^{{134}}/\sqrt{3}; RI=2, PMI=15 are fed back by the user 4, and the pre-coding matrix is W₁₅^{{12}}/\sqrt{2}; and RI=4, PMI=15 are fed back by the user 5, and the pre-coding matrix is W₁₅^{{1234}}/2. CQI_{i,j} is used to represent the CQI corresponding to the jth codeword of the user i.

In steps S810-1 and S810-2, according to the method for user selection provided by the present invention, the user 1, the user 2 and the user 3 that have the same PMI are grouped into one group, corresponding to the user set PMI₉; and the user 4 and the user 5 are grouped into one group, corresponding to the user set PMI₁₅. It can be seen that, in individual user sets, the RI of each user may be the same or not.

In steps S810-1 and S810-2, with respect to the user set PMI₉ and the user set PMI₁₅, the user mating in the user set is performed.

According to the above description, in the user set PMI₉, the user 1 and the user 3 may be grouped into the MU-MIMO transmission user set with the rank of 2 or 3, and the user 2 and the user 3 may be grouped into the MU-MIMO transmission user set with the rank of 3 or 4. If the user 1 and the user 3 may be grouped into the MU-MIMO transmission user set with the rank of 2, then the pre-coding vector corresponding to the user 1 is W₉^{{4}}/\sqrt{2}, the pre-coding vector corresponding to the user 3 is W₉^{{1}}/\sqrt{2}, the pre-coding matrix of the MU-MIMO transmission user set may be obtained by W₉^{{14}}/\sqrt{2}, which is the same as the pre-coding matrix fed back by the user 1, i.e., the second data transmission layer of the user 1 complement with the first data transmission layer of the user 3 to form the mated user set with the rank of 2, and the throughput of this MU-MIMO user pair may be represented as the function of (CQI_{1,2}+CQI_{3,1}). If the user 1 and the user 3 may be grouped into the MU-MIMO transmission user set with the rank of 3, then the pre-coding vector corresponding to the user 1 is W₉^{{1}}/\sqrt{3}, the pre-coding vector corresponding to the user 3 is W₉^{{134}}/\sqrt{3}, the pre-coding matrix of the MU-MIMO transmission user set may be obtained by W₉^{{134}}/\sqrt{3}, which is the same as the pre-coding matrix fed back by the user 3, i.e., the first data transmission layer of the user 1 complement with the second and the third data transmission layers of the user 3 to form the mated user set with the rank of 3, and the throughput of this MU-MIMO user pair may be represented as the function of (CQI_{1,1}+CQI_{3,2}). If the user 2 and the user 3 may be grouped into the MU-MIMO transmission user set with the rank of 3, then the pre-coding vector corresponding to the user 2 is W₉^{{34}}/\sqrt{3}, the pre-coding vector corresponding to the user 3 is W₉^{{1}}/\sqrt{3}, the pre-coding matrix of the MU-MIMO transmission user set may be obtained by W₉^{{134}}/\sqrt{3}, which is the same as the pre-coding matrix fed back by the user 3, i.e., the third and the fourth data transmission layers of the user 2 complement with the first data transmission layer of the user 3 to form the mated user set with the rank of 3, and the throughput of this MU-MIMO user pair may be represented as the function of (CQI_{2,2}+CQI_{3,1}). If the user 2 and the user 3 may be grouped into the MU-MIMO transmission user set with the rank of 4, then the pre-coding vector corresponding to the user 2 is W₉^{{12}}/2, the pre-coding vector corresponding to the user 3 is W₉^{{34}}/2, the pre-coding matrix of the MU-MIMO transmission user set may be obtained by W₉^{{1234}}/2, which is the same as the pre-coding matrix fed back by the user 2, i.e., the first and the second data transmission layers of the user 2 complement with the third and the fourth data transmission layers of the user 3 to form the mated user set with the rank of 3, and the throughput of this MU-MIMO user pair may be represented as the function of (CQI_{2,1}+CQI_{3,2}).

Those skilled in the art know that, the CQI has determined functional relation with the system throughput, which is direct proportion relation, therefore according to the maximum total throughput scheduling rule, comparing (CQI_{1,2}+CQI_{3,1}), (CQI_{1,1}+CQI_{3,2}), (CQI_{2,2}+CQI_{3,1}) and (CQI_{2,1}+CQI_{3,2}) is equivalent to comparing the corresponding system throughput of the corresponding user set. By comparing, one user set having the maximum throughput is selected as the mated users of the user set PMI₉. Provided that (CQI_{2,1}+CQI_{3,2}) is the maximum, then the user 2 and the user 3 are selected to group into the MU-MIMO transmission user set with the rank of 4 to serve as the candidate MU-MIMO transmission user set.

In the user set PMI₁₅, the user 4 and the user 5 can not consist the pre-coding matrix with the rank of 2 or 4, therefore they can no be mated. Specifically, the user 4 feeds back the RI=2, with the mapping relation between the codeword and the data transmission layer being shown in FIG. 4B, i.e., one of the codewords is mapped onto the first data transmission layer, and one of the codewords is mapped onto the second data transmission layer. The user 5 feeds back the RI=4, with the mapping relation between the codeword and the data transmission layer being shown in FIG. 4D, i.e., one of the codewords is mapped onto the first and the second data transmission layers, and one of the codewords is mapped onto the third and the fourth data transmission layers. Obviously, in the user 4, there is only the structure that one codeword that is mapped onto one data transmission layer, and in the user 4, there is the structure that one codeword that is mapped onto two data transmission layers, thus no complement or exchange mating may be implemented between the data transmission layers of these two users.

In a step S830, the throughput of the MU-MIMO user set and the single throughput of the SU-MIMO user 1 to user 5 are compared, so as to select one manner with the maximum throughput to perform the transmission. The throughput of the user 1 is the function of (CQI_{1,1}+CQI_{1,2}), the throughput of the user 2 is the function of (CQI_{2,1}+CQI_{2,2}), the throughput of the user 3 is the function of (CQI_{3,1}+CQI_{3,2}), the throughput of the user 4 is the function of (CQI_{4,1}+CQI_{4,2}), and the throughput of the user 5 is the function of (CQI_{5,1}+CQI_{5,2}). Provided that the user 5 is the user having the maximum throughput in the SU-MIMO single user, then (CQI_{5,1}+CQI_{5,2}) and (CQI_{2,1}+CQI_{3,2}) are compared. If (CQI_{5,1}+CQI_{5,2})>(CQI_{2,1}+CQI_{3,2}), then the user 5 is determined as the scheduled SU-MIMO transmission user, and the data of the user 5 is transmitted in the SU-MIMO transmission mode; otherwise, the user 2 and the user 3 are mated into the MU-MIMO transmission user set with the rank of 4 and this MU-MIMO transmission user set is determined as the scheduled MU-MIMO transmission user set, and the data of the user 2 and the user 3 are transmitted in the MU-MIMO transmission mode. Provided that (CQI_{5,1}+CQI_{5,2})<(CQI_{2,1}+CQI_{3,2}), then the transmission device (such as the base station) will transmit the data of the user 2 and the user 3 in the MU-MIMO mode, and meanwhile the transmission device indicates the pre-coding matrix, used by the user 2 and the user 3 the rank and the mapping relations of respective users by the downlink control channel.

In a specific example, the mapping relations of respective users may be indicated in information of 1 bit, for example “0” indicates that the codewords of the user 2 and the user 3 are arranged in positive-sequence of the number of the data transmission layer, i.e., if the user 2 and the user 3 are mated as the scheduled MU-MIMO user set with the rank of 4, then the user 2 is mapped onto the first and the second data transmission layers, and the user 3 is mapped onto the second and the third data transmission layers; and “1” indicates that the codewords of the user 2 and the user 3 are arranged in reverse-sequence of the number of the data transmission layer, i.e., if the user 2 and the user 3 are mated as the scheduled MU-MIMO user set with the rank of 3, then the user 2 is mapped onto the second and the third data transmission layers, and the user 3 is mapped onto the first data transmission layer. This manner of indicating the positive-sequence or the reverse-sequence of the mapping relation in information of 1 bit helps to decrease the singling overhead of the system.

It can be seen from the above description that, with respect to each user set PMI_{g}, the obtained candidate MU-MIMO transmission user set is the user set in accordance with the predetermined scheduling strategy or rule (for example the maximum system throughput principle) selected form the user sets that are possible to be mated with this user set. Therefore, this candidate MU-MIMO transmission user set actually may be considered as the user set obtained by mating individual users having data transmission layers with better transmission conditions to complement each other with their respective data transmission layers. Correspondingly, in this candidate MU-MIMO transmission user set, the transmission condition of the user set determined through the transmission conditions of the layers participating the complement is the optimal condition among all the possible combinations of the this user set.

In the above example, the scheduled MU-MIMO transmission user set includes two users, however more than two users may also be included, as long as the data transmission layers of the individual users having relatively better transmission conditions may complement with each other to consist the data transmission layer for MU-MIMO transmission.

Further, in the above example, the user set with the highest priority is firstly selected from the multiple candidate MU-MIMO transmission user sets, and then this user set is compared with individual SU-MIMO user, so as to determine the scheduled MU-MIMO transmission user set or the SU-MIMO transmission user. However, those skilled in the art understand that, all the candidate MU-MIMO transmission users may be compared directly with the SU-MIMO transmission users, so as to select the scheduled MU-MIMO transmission user set or the SU-MIMO transmission user according to the predetermined scheduling strategy.

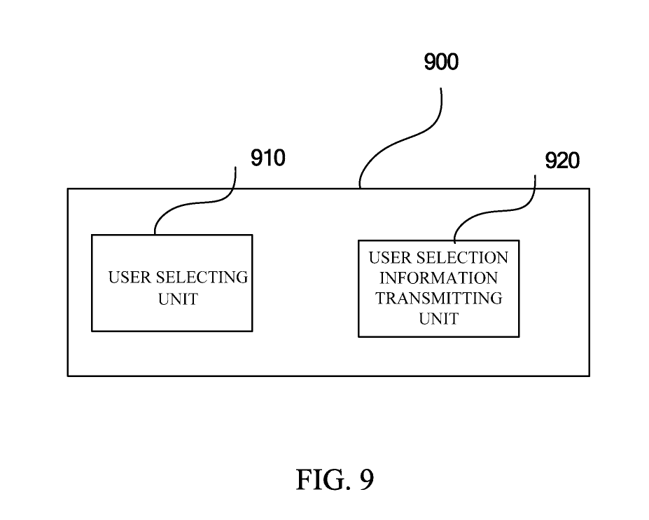

FIG. 9 shows a transmitting device used in a dynamic switching between downlink multi-user multiple-input-multiple-output (MU-MIMO) transmission and downlink single-user multiple-input-multiple-output (SU-MIMO) transmission in a telecommunication system according to an embodiment of the present invention. As shown in FIG. 9, this transmission device 900 includes a user selection unit 910 and a user selection information transmitting unit 920. The user selection unit 910 is configured to group, based on information concerning the MIMO transmission fed back by at least two users capable of implementing the MIMO transmission in the telecommunication system in a single-user feedback manner of the SU-MIMO, the users having the same Precoding Matrix Indicator (PMI) into one user group; and with respect to each of the user groups, cause, based on a predetermined scheduling rule, the users in the user group to complement each other with their respective different data transmission layers with relatively better optimal transmission conditions to form a candidate user set corresponding to the user group, wherein the candidate user set has an optimal combined transmission condition which is determined through the transmission conditions of the layers participating the complement; make a comparison between the candidate user sets obtained for all the user groups with the at least two users, and determine the candidate user set or the user having the highest priority to be the scheduled MU-MIMO transmission user set for performing the MU-MIMO transmission or the scheduled SU-MIMO transmission user for performing the SU-MUMO transmission, wherein the users in said scheduled MU-MIMO transmission user set have same rank or different ranks, and said priority is related to the communication quality of the telecommunication system. The user selection information transmitting unit is configured to transmit the information concerning a transmission mode of each user in said scheduled MU-MIMO transmission user set and determined by the user selecting unit 920 to the respective scheduled users, which information being for use in the downlink MU-MIMO transmission. It should be noted that those common components for the transmission device are not shown in this FIG. 9 to prevent the understanding of the core of the present invention from being blurred.

The transmission device 900 according to this embodiment of the present invention may be configured to various functions that have been described referring to the FIGS. 3-8 and completely disclosed in the present invention although not shown in the drawings in detail. Individual components in the above transmission device 900 may be configured in software, hardware, or combination thereof. The specific means or manner suitable for the configuration are well-known to those skilled in the art, which will not be described in detail here.

Those skilled in the art understand that, the transmission device 900 according to the present invention as shown in FIG. 9 may be implemented as the base station in the telecommunication system, for example, the base station 12 in the telecommunication system as shown in FIG. 1, and may also be implemented as nay other suitable telecommunication device that are able to implement the functions of this kind of this transmission device. For example, if in some telecommunication system, the user selection and scheduling are performed in the downlink MIMO transmission, and the transmission of the information concerning the transmission conditions of the scheduled user to the corresponding user is not implemented by the base station but other telecommunication device or implemented by the base station in coordination with other telecommunication device, then this kind of other telecommunication device should obviously be considered as being included in the scope of the above transmission device 900 according to the present invention.

It can be seen from the above description that, according to the method of user selection and user scheduling used in a dynamic switching between downlink MU-MIMO transmission and downlink SU-MIMO transmission, the problem of the mismatching between the CQI of the SU-MIMO transmission and the CQI of the MU-MIMO transmission are solved better by mating the users having the same PMI and the same or different RI. According to this method, the user may be selected may be selected in the case of different ranks, thus the range for selecting the user set is increased. Because this method supports the high rank transmission mode of each user and the switching between the SU-MIMO transmission and the MU-MIMO transmission, the system throughput is improved. Further, if the code book defined in the LTE system is used in the user selection and scheduling in the downlink MU-MIMO transmission, then the orthogonality between the pre-coding matrix (vector) is ensured by grouping the users having the same PMI into the same group, and the interference between the users in the MU-MIMO transmission is further avoided. Moreover, the downward compatibility is also ensured by using the code book defined in the LTE system.

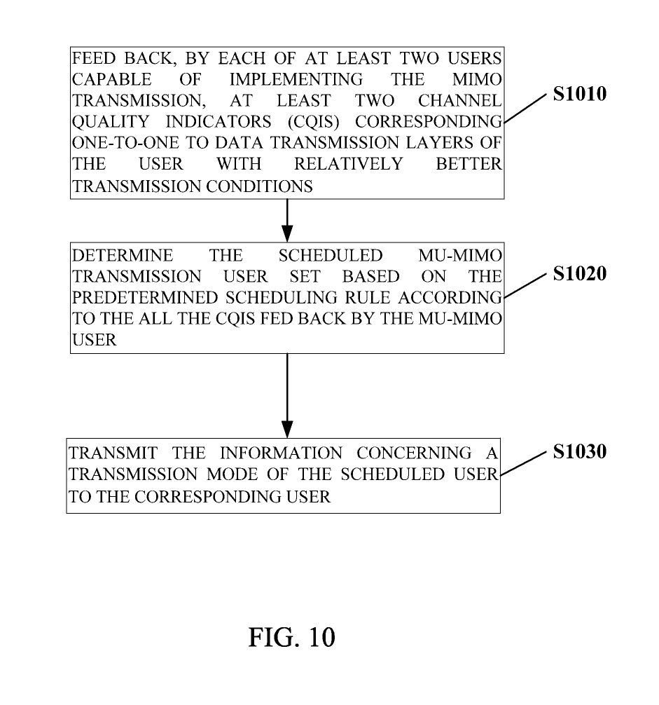

The method of user feeding back and user selection and scheduling, the transmitting device and the user equipment used in a semi-static switching between downlink MU-MIMO transmission and downlink SU-MIMO transmission will be described in conjunction with FIG. 10-14 hereinafter.

FIG. 10 is a simplified flow chart showing this method of user feeding back and user selection and scheduling according to other embodiments of the present invention. As shown in FIG. 10, in a user feeding back step, each of at least two users capable of implementing the MIMO transmission in the telecommunication system feeds back at least two channel quality indicators (CQIs) corresponding one-to-one to data transmission layers of the user having better transmission conditions. In a user selecting step, selection and scheduling is made based on a predetermined scheduling rule, with respect to the at least two users according to all the CQIs fed back by the at least two users, so as to determine a scheduled MU-MIMO transmission user set for performing the MU-MIMO transmission, wherein each user in said scheduled MU-MIMO transmission user set corresponds to one codeword or multiple codewords. In a user selection information transmitting step, the information concerning a transmission mode of each user in said scheduled MU-MIMO transmission user set is transmitted to the respective scheduled users, which information being for use in the downlink MU-MIMO transmission.

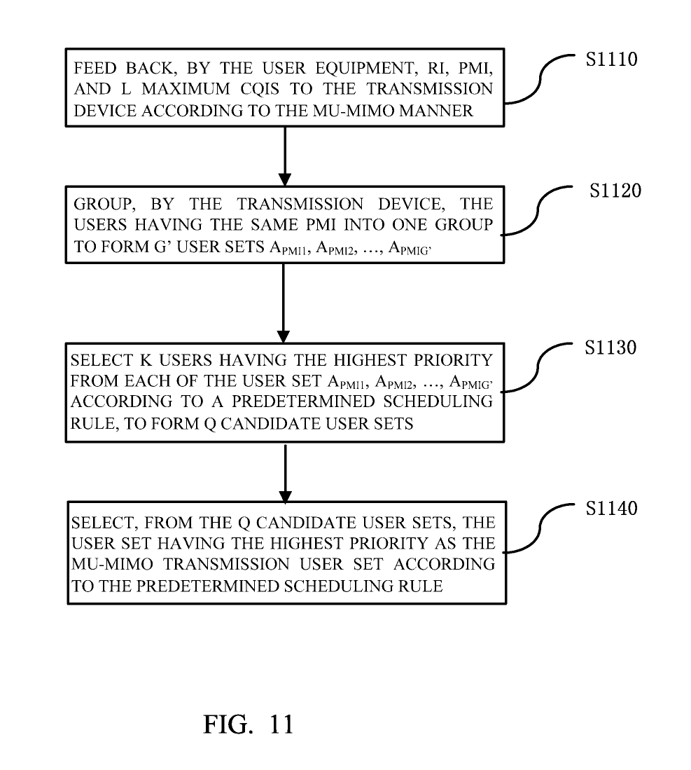

FIG. 11 is a simplified flow chart showing a specific example of a method of user feeding back and user selection and scheduling according to an embodiment of the present invention. Provided that the transmission device uses the unitary matrix-based pre-coding mode. As shown in FIG. 11, this method of user feeding back and user selection and scheduling includes specifically the following steps.

In a step S1110, in the user equipment, individual users feed back, according to the MU-MIMO transmission mode predefined by the system, the present optimal RI, PMI and L COQ values. The L CQI values correspond to L data streams having the maximum throughput in the M_{L} data streams in the MU-MIMO system, in which the M_{L} is the rank of the MU-MIMO transmission. It can be seen that, in this method, the user equipment feeds back the CQI in the unit of the data transmission layer, however in the present downlink MU-MIMO transmission, the user equipment feeds back the CQI in the unit of the its codeword.

In a step S1120, the transmission device (such as the base station) groups, from the M users that are serviced, the users having the same PMI into the user sets A_{PMI}_{₀}, A_{PMI}_{₁}, . . . , A_{PMI}_{_{G}}, according to the PMIs fed back by the users.

In a step S1130, K users having the highest priority are selected from each user set A_{PMI}_{_{g}} according to a certain scheduling strategy to performing mating on them, in which the total number of the data transmission layer of the K users is equal to M_{L}.

In a step S1140, the transmission device selects a optimal user set from the K mated users in each user set A_{PMI}_{_{g}}, as the candidate MU-MIMO transmission user combination, wherein the total number of the data transmission layer of the K users in one set is equal to M_{L}. And then the user set having the highest priority is selected from the candidate MU-MIMO transmission user combination obtained with respective to all the user sets, as the scheduled MU-MIMO transmission user set, for performing the MU-MIMO transmission.

In the method of user feeding back and user selection and scheduling according to the embodiment of the present invention, for example, by the downlink control channel, the transmission device may indicate the pre-coding matrix, the number of the data transmission layer of the scheduled MU-MIMO transmission user and the mapping relation of the data streams of the scheduled user.

It should be noted that, in the method of user feeding back and user selection and scheduling used in a semi-static switching between downlink MU-MIMO transmission and downlink SU-MIMO transmission according to this embodiment of the present invention, the MU-MIMO transmission is firstly predetermined by the system, and compared with the method of user feeding back and user selection and scheduling used in a dynamic switching between downlink MU-MIMO transmission and downlink SU-MIMO transmission described above, the method according to this embodiment may be referred to as the “semi-static” method of user selection and scheduling in the MU-MIMO transmission. In other words, in a specific present time period, it is determined to perform the MU-MIMO transmission without the switching between the MU-MIMO and the SU-MIMO, thus this method is not the same as the above “dynamic switching” method. However, this determined MU-MIMO transmission mode is performed only in the specific time period but not all the time, thus this mode is not completely a static mode, and referred to as a “semi-static” switching mode. Correspondingly, the parameters for MU-MIMO transmission predetermined by the system include the rank of this MU-MIMO transmission and the number of the CQI that needs to be fed back by the user equipment. According to the present telecommunication resource allocation in the system and any one or two combinations of the telecommunication history information in a certain time period, the system may predetermine the rank of this MU-MIMO transmission. For example, if the possibility of using the MU-MIMO transmission mode by the system in a time period is higher, and the present telecommunication resource in the system is relatively ideal, then the MU-MIMO transmission is determined to be performed in the following time period, so as to increase the system throughput and decrease the interference between the users in the system. Further, by priori judgment for the transmission condition of the user equipment, the system may also determine the number of the CQI that needs to be fed back by the user equipment. For example, if in a relatively long time period, the transmission conditions of a certain user corresponding to two data transmission layers are better, then the system may use the two CQIs fed back by the user in the user mating. According to this, the number L of the CQI fed back by each user may be the same or not. It is easy to understand that, the transmission conditions of each user may not be the same, thus number of the CQI fed back by each user may be not the same.

As described above, in the method of user selection and scheduling according to this embodiment of the present invention, each user feeds back the CQI in the order of the data transmission layer but not the codeword as in the conventional method. Thereby, if multiple data transmission layers of a user have better transmission condition, then the system may use the multiple CQIs corresponding to these multiple data transmission layers fed back by the user, for using in the user selection and scheduling in the MU-MIMO transmission. In other words, this user feeding back manner supports the transmission mode of multiple codewords/layer of each user in the transmission device, which increased the range for selecting the user set, ensures more multiple user diversity gain and system throughput obtained in the system, and decrease the signaling overhead. In the user equipment, channel quality indicators of multiple codewords/layers are fed back, for providing the information necessary for selecting multiple codewords/layers transmission by each user.

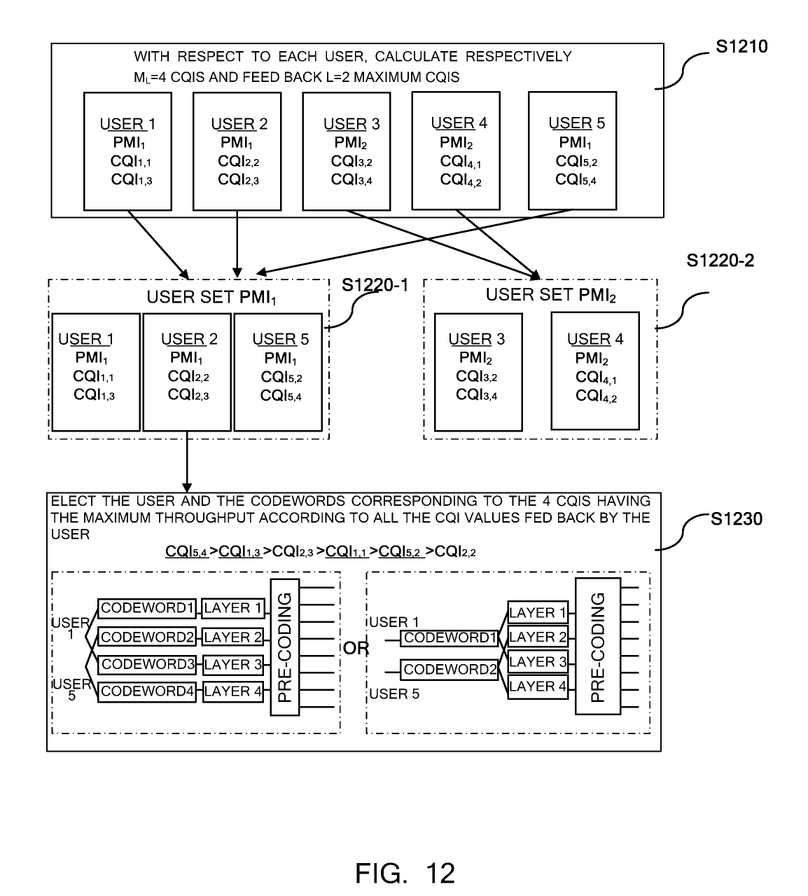

FIG. 12 is a detailed flow chart showing a method of user feeding back and user selection and scheduling for use in a semi-static switching between downlink MU-MIMO transmission and downlink SU-MIMO transmission as that shown in FIG. 11. Provided that the unitary matrix-based pre-coding mode is used in the transmission device, then the method of user feeding back and user selection and scheduling according to this embodiment includes specifically the following steps.

In a step S1210, in the user equipment, individual users feed back, according to the MU-MIMO transmission mode predefined by the system, the present optimal RI, PMI and L COQ values. The L CQI values correspond to L data streams having the maximum throughput in the M_{L} data streams in the MU-MIMO system. Provided that the rank of the MU-MIMO transmission M_{L}=4, the number of the CQI fed back by each user is L=2, and CQI_{i,j} is used to represent the CQI corresponding to the jth codeword of the user i. It assumed that, with respect to the user 1, the CQIs of the first and the third data transmission layers are the maximum; with respect to the user 2, the CQIs of the second and the third data transmission layers are the maximum; with respect to the user 3, the CQIs of the second and the fourth data transmission layers are the maximum; with respect to the user 4, the CQIs of the first and the second data transmission layers are the maximum; and with respect to the user 5, the CQIs of the second and the fourth data transmission layers are the maximum. Then the user 1 feeds back CQI_{1,1} and CQI_{1,3}; the user 2 feeds back CQI_{2,1} and CQI_{2,3}; the user 3 feeds back CQI_{3,2} and CQI_{3,4}; the user 4 feeds back CQI_{4,1} and CQI_{4,3}; and the user 5 feeds back CQI_{5,2} and CQI_{5,4}.

In steps S1220-1 and S1220-2, the base station groups the users, in the 5 users that are able to perform the downlink MIMO transmission and to which the service is provided by the system, having the same PMI in to one group according to the PMI fed back by the user. It is assumed that the user 1, the user 2 and the user 5 have the same PMI, corresponding to the user set PMI₁, and the user 3 and the user 4 have the same PMI, corresponding to the user set PMI₂.

In a step S1230, with respect to the user sets PMI₁ and PMI₂, the users in the user set are selected. According to a specific scheduling strategy, K users having the highest priority are selected from each user set for mating, and the total number of the data transmission layers corresponding to the K users is equal to M_{L}. With respect to the user set PMI₁, provided that CQI_{5,4}>CQI_{1,3}>CQI_{2,3}>CQI_{1,1}>CQI_{5,2}>CQI_{2,2}, then the base station will determine that the user 1 and the user 5 are the candidate MU-MIMO transmission user set of the user set PMI₁, and the data of the user 1 and the user 5 is transmitted in the MU-MIMO transmission mode, in which the user 1 is mapped onto the first data transmission layer and the third transmission layer in the MU-MIMO transmission, and the user 5 is mapped onto the second data transmission layer and the fourth transmission layer in the MU-MIMO transmission. And with respect to the user set PMI₂, the user 3 and the user 4 can not constitute the unitary matrix with the rank of 4 for mating. Therefore, the user 5 and the user 1 constitute the scheduled downlink MU-MIMO transmission user set.

In the above embodiment, if the user 3 and the user 4 are able to be mated to form another candidate MU-MIMO transmission user set, then according to a predetermined scheduling strategy (for example the maximum system throughput principle), the two user sets are further compared, to select the user set having higher throughput as the scheduled MU-MIMO transmission user set.

In a preferred embodiment, when the user feeds back the present optimal RI, PMI and multiple CQI values, the user equipment will calculate respectively the CQI values corresponding to the multiple data streams, and feed back the first L COQ values in the order from the larger to the smaller.

When the user feeds back the present optimal RI, PMI and multiple CQI values, if the transmission device uses the unitary matrix-based pre-coding mode, then the following formula (1), described in the “3GPP long term evolution technical principle and system design” (People's Posts and Telecom Press) to the Shen Jia, Shiqiang Suo, et al., may be used to calculate the SINR (signal to interference noise ratio) corresponding to the jth data stream:

$${SINR}_{j}^{i} = \frac{{\vert {u}_{i} ( j , : ) {\overline{H}}_{i} ( : , j ) \vert}^{2}}{{σ}_{n}^{2} {‖ {u}_{i} ( j , : ) ‖}_{2}^{2} + {\sum }_{k \neq j} {\vert {u}_{i} ( j , : ) {\overline{H}}_{i} ( : , k ) \vert}^{2}} \qquad ( 1 )$$

In which uᵢ is the weighed vector in the user equipment, H̅ᵢ=HGᵢ is the equivalent channel in the case of using the pre-coding matrix Gᵢ, and σₙ² is the Gaussian noise variance.

Those skilled in the art know that, the SINR and the CQI have determined relation, and thus the CQI value may be obtained by using the value of the corresponding SINR, for example, by looking up the table reflecting the relation between the SINR and the CQI defined in the LTE standard.

In one specific embodiment, when K user sets having the highest priority are selected according to the specific scheduling strategy, the maximum system throughput may be used as the scheduling strategy or the scheduling rule. Other scheduling strategy giving attention to equality of the user, delay characteristic, and/or combination thereof may also be adopted. Further, the priority corresponding to the transmission user may be the parameters or the indexes concerning the telecommunication quality of the telecommunication system, for example, the priority may represent any one of the system throughput, the equality of the user, and the delay characteristic, or may represent the any weighted array of these performance indexes.

When K user sets having the highest priority are selected according to a specific scheduling strategy, each user may be mapped onto a single or multiple codewords. The base station may allocate a single or multiple data streams to each codeword of the user.

In one specific embodiment, when the base station may allocate multiple data streams to each codeword of the user, the base station will determine the combined single codeword modulation and coding mode based on the selected COI information of each codeword, according to a specific adaptive modulation and coding algorithm, such as considering both the CQI value of each codeword and the length of the coding block after the mapping of codeword to the data stream. So that the spectrum effectiveness corresponding to this modulation and coding mode is the average of the spectrum effectiveness corresponding to the modulation and coding mode of each codeword. The multiple of codewords are combined according to the selected modulation and coding mode, so as to select the length of the corresponding single codeword. Further, the single codeword of the user is mapped onto multiple data streams. In the example shown in FIG. 12, in the scheduled MU-MIMO transmission user set, the user 1 is mapped onto the first and the third data transmission layers in the MU-MIMO transmission, and each layer may corresponds to a single codeword, as shown in lower left corner of FIG. 12; and two layers may corresponds to a single codeword, as shown in lower right corner of FIG. 12. The flexible data layer mapping mechanism may decrease the downlink signaling overhead, so as to improve the system transmission efficiency. For example, if the present system resource is not enough for supporting the signal overhead required by mapping individual data communication layers onto the single codeword, then the multiple codewords of the user may be combined into one codeword in the above mode.

In an alternative embodiment, in combing the codewords with respect to a certain user, the spectrum effectiveness corresponding to this modulation and coding mode may be caused to be the weighted combination value of the spectrum effectiveness corresponding to the modulation and coding mode of each codeword, or the spectrum effectiveness corresponding to this modulation and coding mode may be caused to be the maximum or the minimum in the spectrum effectiveness corresponding to the modulation and coding mode of each codeword.

Except for the above unitary matrix-based pre-coding mode, the method of user feeding back and user selection and scheduling used in a semi-static switching between downlink MU-MIMO transmission and downlink SU-MIMO transmission is also adaptive to the Zero-Forcing beamforming-based pre-coding mode and the like. When the transmission device uses the Zero-Forcing beamforming-based pre-coding mode, the following formula (2), disclosed in the “On transceiver design and channel quantization for downlink multiuser MIMO systems with limited feedback”, IEEE Journal on Selected Areas in Communications, Volume: 26, Issue: 8, page(s): 1494-1504, in the name of Trivellato, M. Boccardi, F. Huang, H or the submission “Comparison of MU-MIMO feedback schemes with multiple UE receive antennas” proposed by Philips corporation in 3GPP TGS RAN WGI Metting 47 bits (R1-070346), to calculate the CQI corresponding to the jth data stream.

$${SINR}_{j} = \frac{\frac{P}{M} {‖ {h}_{{eff}_{j}} ‖}^{2} {cos}^{2} {θ}_{j}}{{σ}_{n}^{2} + \frac{P}{M} {‖ {h}_{{eff}_{j}} ‖}^{2} {sin}^{2} {θ}_{j}} \qquad ( 2 )$$

In which h_{eff}_{ⱼ} is the equivalent channel, θⱼ is the angle between the equivalent channel h_{eff}_{ⱼ}, cos θⱼ=|h_{eff}_{ᵢ}ĥⱼ^{H}|, and the quantized vector ĥⱼ, P is the total transmission power, and M is the rank of the MU-MIMO transmission.

In the above method of user feeding back and user selection and scheduling according to this embodiment of the present invention, if the transmission device uses the unitary matrix-based pre-coding mode, then the system may solve better the problem of the CQI mismatching; and if the transmission device uses the Zero-Forcing beamforming-based pre-coding mode, the system may solve better the problem of the interference between the multiple users.

Further, in this method according to the embodiment of the present invention, the multi-CQI fed back mechanism is provided, and the multiple-codewords or multiple-data streams transmission of the user in the MU-MIMO transmission is supported flexibly, so that the freedom of the user selection is increased, so better multi-user diversity gain may be obtained.

In the method of user feeding back and user selection and scheduling according to the embodiment of the present invention, the transmission device may indicate, by the downlink control channel, the pre-coding matrix, the number of the data transmission layer of the scheduled MU-MIMO transmission user and the mapping relation of the data streams of the scheduled user.

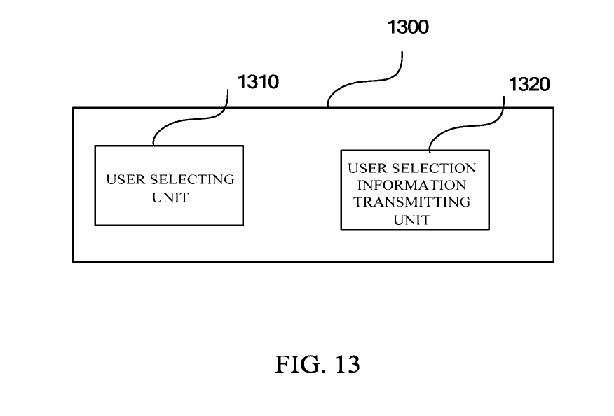

FIG. 13 is a simplified diagram showing a transmission device used in a semi-static switching between downlink multi-user multiple-input-multiple-output (MU-MIMO) transmission and downlink single-user multiple-input-multiple-output (SU-MIMO) transmission in a telecommunication system according to an embodiment of the present invention. This transmission device 1300 includes a user selecting unit 1310 and a user selection information transmitting unit 1320. The user selecting unit 1310 is configured to make selection and scheduling, based on a predetermined scheduling rule, with respect to at least two users capable of implementing the MIMO transmission in the telecommunication system according to all channel quality indicators (CQIs) which include at least two CQIs fed back by each of the at least two users and corresponding one-to-one to data transmission layers having better transmission conditions of said each user, so as to determine a scheduled MU-MIMO transmission user set, wherein each user in said scheduled MU-MIMO transmission user set corresponds to one codeword or multiple codewords. The user selection information transmitting unit 1320 is configured to transmit the information concerning a transmission mode of each user in said scheduled MU-MIMO transmission user set to the respective scheduled users, which information being for use in the MU-MIMO transmission. It should be noted that those common components for the transmission device are not shown in this FIG. 13 to prevent the understanding of the core of the present invention from being blurred.

The transmission device 1300 according to this embodiment of the present invention may be configured to various functions that have been described referring to the FIGS. 10-12 and completely disclosed in the present invention although not shown in the drawings in detail.

Those skilled in the art understand that, the transmission device 1300 according to the present invention as shown in FIG. 13 may be implemented as the base station in the telecommunication system, and may also be implemented as nay other suitable telecommunication device that are able to implement the functions of this kind of this transmission device. For example, if in some telecommunication system, the user selection and scheduling are performed in the downlink MU-MIMO transmission, and the transmission of the information concerning the transmission conditions of the scheduled user to the corresponding user is not implemented by the base station but other telecommunication device or implemented by the base station in coordination with other telecommunication device, then this kind of other telecommunication device should obviously be considered as being included in the scope of the above transmission device 1300 according to the present invention.

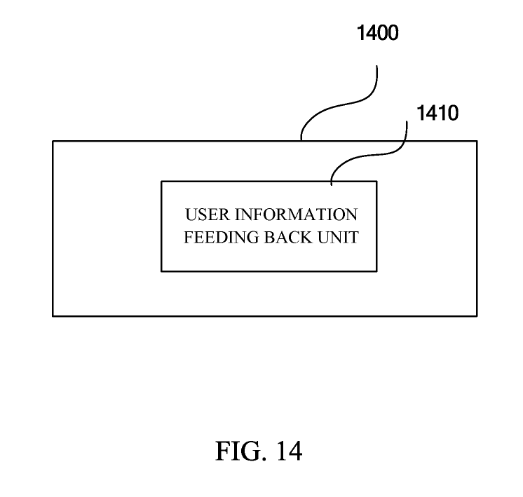

FIG. 14 is a simplified diagram showing a user equipment 1400 used in a semi-static switching between downlink multi-user multiple-input-multiple-output (MU-MIMO) transmission and downlink single-user multiple-input-multiple-output (SU-MIMO) transmission in a telecommunication system according to an embodiment of the present invention. This user equipment 1400 includes a user information feeding back unit 1410, which is configured to feed back to a transmitting device of the system at least two channel quality indicators (CQIs) corresponding one-to-one to data transmission layers of the user equipment having better transmission conditions, wherein the CQIs are to be used in user selection and scheduling performed by the transmitting device during the semi-static switching between the MU-MIMO transmission and SU-MIMO transmission. Similarly, those common components for the transmission device are not shown in this FIG. 14 to prevent the understanding of the core of the present invention from being blurred.

In an preferred embodiment, by priori judgment for the transmission condition of the user equipment, the system may also determine the number of the CQIs that needs to be fed back by the user equipment.

Those skilled in the art understand that, the user equipment 1400 according to the present invention as shown in FIG. 14 may be implemented as the mobile station in the telecommunication system, for example, the mobile station 10 or 10′ in the telecommunication system as shown in FIG. 1, and may also be implemented as nay other suitable telecommunication device that are able to implement the functions of this kind of this user equipment. For example, if in some telecommunication system, the user selection and scheduling are performed in the downlink MU-MIMO transmission, and the transmission of the information concerning the transmission conditions of the scheduled user to the corresponding user is not implemented by the user equipment but other telecommunication device or implemented by the user equipment in coordination with other telecommunication device, then this kind of other telecommunication device should obviously be considered as being included in the scope of the above user equipment 1400 according to the present invention.

It should be noted that, the above user equipment and individual components in the user equipment may be configured in software, hardware, or combination thereof. The specific means or manner suitable for the configuration are well-known to those skilled in the art, which will not be described in detail here.

Although the above detailed description are given in conjunction with the LTE system, those skilled in the art understand that, the method of user selection and user scheduling used in a dynamic or semi-static switching between downlink MU-MIMO transmission and downlink SU-MIMO transmission according to the embodiment of the present invention may also be used in other similar telecommunication systems, including but not limited to the WiMax/WiFi communication system.

Other embodiment of the present invention further provides a downlink MIMO telecommunication system, which may include the transmission device and the user equipment according to the embodiment of the present invention.

Further, the method according to individual embodiments of the present invention may be implemented by a program product comprising machine readable instruction codes. These instruction codes are read and executed by the machine such as computer, so as to individual processes and steps of the method of user selection and user scheduling used in a dynamic or “semi-static” switching between downlink MU-MIMO transmission and downlink SU-MIMO transmission according to the embodiment of the present invention. This program product may have any form, such as object program, programs executed by the interpreter, or script programs provided to the operating system.

Correspondingly, the machine readable storage medium for carrying the above program product comprising machine readable instruction codes is also included in the disclosure of the present invention. The storage medium includes but not limited to soft disk, optical disk, magnetic disk, storage card, or the like.

It can be seen from the above description made to the embodiments of the present invention, the technical solutions contained in the present invention includes but not limited to the following content.

In the above description of the embodiment of the present invention, the characteristics described and/or introduced with respect to one embodiment may be used, in the same or similar manner, in one or more other embodiments, in combination with the characteristics in other embodiments, or for replacing the characteristics in other embodiments.

Further, the method of the present invention is not limited to be performed in the time sequencing described in this description, but may also be performed in other time sequencing, concurrently, or independently. Therefore, the performing order described in this description is not intended to limit the technical scope of the present invention.

Finally, it is necessary not be noted that, in the present invention, relation terms such as “first” and “second” are used only to distinguish one entity or operation from the other entity or operation, but not sure to demand or indicate that there are those actual relations or orders among those entities and operations. Furthermore, the terms “including”, “comprising”, or any other grammatical variations are used in the inclusive sense of “comprising”, so that process, method, article or device that includes series of the elements include not only those elements but also other elements that are not listed, or further include inherent elements of this process, method, article or device. In the case of no more restriction, an element defined by the sentence “including one” does not indicate that there are no other same elements in the process, method, article or device that includes said element.

Although the present invention and the advantages thereof have been described in detail, it should be understood that, various variations, alternations and modifications may be made without deviating from the spirit and the scope of the present invention defined by the appended claims. Moreover, the scope of this application is not limited to the described specific embodiments of the procedure, device, fabrications, structure of the material, means, methods and steps. It should be understood easily by those skilled in the art that, according to the present invention, it is possible to use the present procedure, device, fabrications, structure of the material, means, methods and steps and those to be developed which perform the function similar to that of the embodiment described here and obtain the similar result.

What is claimed is:

1. A method of user selection and user scheduling used in a dynamic switching between downlink multi-user multiple-input-multiple-output (MU-MIMO) transmission and downlink single-user multiple-input-multiple-output (SU-MIMO) transmission in a telecommunication system, comprising:
a user feeding back step of feeding back, by at least two users capable of implementing the MIMO transmission in the telecommunication system, information concerning the MIMO transmission in a single-user feedback manner of the SU-MIMO;
a user selecting step of grouping the users having the same Precoding Matrix Indicator (PMI) into one user group based on the information fed back by the at least two users; and with respect to each of the user groups, causing, based on a predetermined scheduling rule, the users in that user group to complement each other with their respective different data transmission layers with relatively better transmission conditions, to form a candidate user set corresponding to the user group, wherein the candidate user set has an optimal combined transmission condition which is determined through the transmission conditions of the layers participating the complement; making a comparison between the candidate user sets obtained for all the user groups and the at least two users, and determining the candidate user set or the user having the highest priority to be the scheduled MU-MIMO transmission user set for performing the MU-MIMO transmission or the scheduled SU-MIMO transmission user for performing the SU-MUMO transmission, wherein the users in said scheduled MU-MIMO transmission user set have same rank or different ranks, and said priority is related to the communication quality of the telecommunication system; and
a user selection information transmitting step of transmitting the information concerning a transmission mode of each user in said scheduled MU-MIMO transmission user set and determined in said user selecting step to the respective scheduled users, which information being for use in the downlink MU-MIMO transmission.

2. The method of claim 1, wherein a precoding code book as regulated in the Long Term Evolution (LTE) is used during the MU-MIMO transmission or SU-MIMO transmission, and wherein if the scheduled transmission user set is the MU-MIMO transmission user set for performing the MU-MIMO transmission, a pre-coding matrix of the MU-MIMO transmission is the same as a pre-coding matrix of one user in the scheduled MU-MIMO transmission user set.

3. The method of claim 1, wherein the information concerning the transmission mode of each user in said scheduled MU-MIMO transmission user set comprises the number of the data transmission layers of said user to be used in the MU-MIMO transmission and mapping relation between a codeword corresponding to said user and the data transmission layers for the MU-MIMO transmission.

4. The method of claim 2, wherein the information concerning the transmission mode of each user in said scheduled MU-MIMO transmission user set comprises the number of the data transmission layers of said user to be used in the MU-MIMO transmission and mapping relation between a codeword corresponding to said user and the data transmission layers for the MU-MIMO transmission.

5. A transmitting device used in a dynamic switching between downlink multi-user multiple-input-multiple-output (MU-MIMO) transmission and downlink single-user multiple-input-multiple-output (SU-MIMO) transmission in a telecommunication system, comprising:
a user selecting unit configured to group, based on information concerning the MIMO transmission fed back by at least two users capable of implementing the MIMO transmission in the telecommunication system in a single-user feedback manner of the SU-MIMO, the users having the same Precoding Matrix Indicator (PMI) into one user group; and with respect to each of the user group, cause, based on a predetermined scheduling rule, the users in that user group to complement each other with their respective different data transmission layers with relatively better transmission conditions, to form a candidate user set corresponding to the user group, wherein the candidate user set has an optimal combined transmission condition which is determined through the transmission conditions of the layers participating the complement; make a comparison between the candidate user sets obtained for all the user groups with the at least two users, and determine the candidate user set or the user having the highest priority to be the scheduled MU-MIMO transmission user set for performing the MU-MIMO transmission or the scheduled SU-MIMO transmission user for performing the SU-MUMO transmission, wherein the users in said scheduled MU-MIMO transmission user set have same rank or different ranks, and said priority is related to the communication quality of the telecommunication system; and
a user selection information transmitting unit configured to transmit the information concerning a transmission mode of each user in said scheduled MU-MIMO transmission user set and determined in said user selecting unit to the respective scheduled users, which information being for use in the downlink MU-MIMO transmission.

6. The transmitting device of claim 5, wherein a precoding book as regulated in the Long Term Evolution (LTE) is used during the MU-MIMO transmission or SU-MIMO transmission, and wherein if the scheduled transmission user set is the MU-MIMO transmission user set for performing the MU-MIMO transmission with the transmitting device, a pre-coding matrix of the MU-MIMO transmission is the same as a pre-coding matrix of one user in the scheduled MU-MIMO transmission user set.

7. The transmitting device of claim 5, wherein the information concerning the transmission mode of each user in said scheduled MU-MIMO transmission user set comprises the number of the data transmission layers of said user to be used in the MU-MIMO transmission and mapping relation between a codeword corresponding to said user and the data transmission layers for the MU-MIMO transmission.

8. The transmitting device of claim 6, wherein the information concerning the transmission mode of each user in said scheduled MU-MIMO transmission user set comprises the number of the data transmission layers of said user to be used in the MU-MIMO transmission and mapping relation between a codeword corresponding to said user and the data transmission layers for the MU-MIMO transmission.

9. A method of user feeding back and user selection and scheduling used in a semi-static switching between downlink multi-user multiple-input-multiple-output (MU-MIMO) transmission and downlink single-user multiple-input-multiple-output (SU-MIMO) transmission in a telecommunication system, comprising:
a user feeding back step of feeding back, by each of at least two users capable of implementing the MIMO transmission in the telecommunication system, at least two channel quality indicators (CQIs) corresponding one-to-one to data transmission layers of the user with relatively better transmission conditions;
a user selecting step of making selection and scheduling, based on a predetermined scheduling rule, with respect to the at least two users according to all the CQIs fed back by the at least two users, so as to determine a scheduled MU-MIMO transmission user set for performing the MU-MIMO transmission, wherein each user in said scheduled MU-MIMO transmission user set corresponds to one codeword or multiple codewords; and
a user selection information transmitting step of transmitting the information concerning a transmission mode of each user in said scheduled MU-MIMO transmission user set to the respective scheduled users, which information being for use in the downlink MU-MIMO transmission.

10. The method of claim 9, wherein the user selecting step further comprises performing the following processes with respect to each of one or more users among at least one user in said scheduled MU-MIMO transmission user set if said at least one user corresponds to multiple codewords:
determining, based on the CQI of each codeword of the user selected for the MU-MIMO transmission, a modulation and coding mode of a single combined codeword of the user according to a pre-set adaptive modulation and coding algorithm; and
combining the multiple codewords to select a length of the single combined codeword according to said determined modulation and coding mode, and mapping the single combined codeword to multiple data transmission layers assigned to said multiple codewords.

11. The method of claim 9, wherein a transmitting device in the telecommunication system carries out pre-coding by using a unitary matrix-based pre-coding mode or a Zero-Forcing (ZF) beamforming-based pre-coding mode.

12. The method of claim 10, wherein a transmitting device in the telecommunication system carries out pre-coding by using a unitary matrix-based pre-coding mode or a Zero-Forcing (ZF) beamforming-based pre-coding mode.

13. A user equipment used in a semi-static switching between downlink multi-user multiple-input-multiple-output (MU-MIMO) transmission and downlink single-user multiple-input-multiple-output (SU-MIMO) transmission in a telecommunication system, comprising:
a user information feeding back unit configured to feed back to a transmitting device of the system at least two channel quality indicators (CQIs) corresponding one-to-one to data transmission layers of the user equipment with relatively better transmission conditions, wherein the CQIs are to be used in user selection and scheduling performed by the transmitting device during the semi-static switching between the MU-MIMO transmission and SU-MIMO transmission.

14. A transmitting device used in a semi-static switching between downlink multi-user multiple-input-multiple-output (MU-MIMO) transmission and downlink single-user multiple-input-multiple-output (SU-MIMO) transmission in a telecommunication system, comprising:
a user selecting unit configured to make selection and scheduling, based on a predetermined scheduling rule, with respect to at least two users capable of implementing the MIMO transmission in the telecommunication system according to all channel quality indicators (CQIs) which include at least two CQIs fed back by each of the at least two users and corresponding one-to-one to data transmission layers of the user with relatively better transmission conditions, so as to determine a scheduled MU-MIMO transmission user set for performing the MU-MIMO transmission with the transmitting device, wherein each user in said scheduled MU-MIMO transmission user set corresponds to one codeword or multiple codewords; and
a user selection information transmitting unit configured to transmit the information concerning a transmission mode of each user in said scheduled MU-MIMO transmission user set to the respective scheduled users, which information being for use in the MU-MIMO transmission.

15. The transmitting device of claim 14, wherein the user selecting unit is further configured to perform the following processes with respect to each of one or more users among at least one user in said scheduled MU-MIMO transmission user set if said at least one user corresponds to multiple codewords:
determining, based on the CQI of each codeword of the user selected for the MU-MIMO transmission, a modulation and coding mode of a single combined codeword of the user according to a pre-set adaptive modulation and coding algorithm; and
combining the multiple codewords to select a length of the single combined codeword according to said determined modulation and coding mode, and mapping the single combined codeword to multiple data transmission layers assigned to said multiple codewords.

16. A program product comprising machine readable instruction codes stored therein, wherein the instruction codes, when read and executed by a computer, are capable of causing the machine to execute the method according to claim 1.

17. A program product comprising machine readable instruction codes stored therein, wherein the instruction codes, when read and executed by a computer, are capable of causing the machine to execute the method according to claim 9.

18. A machine readable storage medium with the program product according to claim 16 carried thereon.

19. A machine readable storage medium with the program product according to claim 17 carried thereon.
